(19) United States
(12) Patent Application Publication
(10) Pub. No.: US 2012/0150756 A1
(43) Pub. Date: Jun. 14, 2012

(54) Ecological impact quantification identifiers

(75) Inventors: Christian L. Belady, Mercer Island, WA (US); Rob Bernard, Redmond, WA (US); Angel Sarmento Calvo, Redmond, WA (US); Larry Cochrane, Redmond, WA (US); Jason Garms, Redmond, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Jennifer Mame Pollard, Redmond, WA (US); John D. Rinaldo, JR., Bellevue, WA (US); Clarence T. Tegreene, Bellevue, WA (US); Rene A. Vega, Scotts Valley, CA (US); Lowell L. Wood, JR., Bellevue, WA (US); Feng Zhao, Redmond, WA (US)

(73) Assignee: Elwha LLC, a limited liability corporation of the State of Delaware

(21) Appl. No.: 13/199,476

(22) Filed: Aug. 31, 2011

Related U.S. Application Data
(63) Continuation-in-part of application No. 12/928,638, filed on Dec. 14, 2010.
Application No. 12/928,638 is a continuation-in-part of application No. 13/135,674, filed on Jul. 12, 2011.
Application No. 13/135,674 is a continuation-in-part of application No. 13/135,683, filed on Jul. 12, 2011.
Application No. 13/135,683 is a continuation-in-part of application No. 13/199,475, filed on Aug. 31, 2011.

(51) Int. Cl. G06Q 99/00

(52) U.S. Cl. 705/317

(57) ABSTRACT

Systems and methods for providing ecological impact quantification identifiers may implement operations including, but not limited to: computing an ecological impact quantification associated with manufacturing at least a portion of a product according to product specification data associated with the product; and means for associating a device-readable indicator corresponding to the ecological impact quantification associated with manufacturing at least a portion of a product with a product manufactured at least partially according the product specification data.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications, including any priority claims, is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 12/928,638, entitled LIFECYCLE IMPACT INDICATORS, naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed 14 Dec. 2010, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/135,674 having an entitled EFFICIENCY-OF-USE TECHNIQUES, naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Jul. 12, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/135,683 entitled USER AS PART OF A SUPPLY CHAIN, naming Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Jul. 12, 2011, which is currently co-pending or is an application of which a currently co-pending application is entitled to the benefit of the filing date.

For purposes of the USPTO extra-statutory requirements, the present application constitutes a continuation-in-part of the United States patent application having Attorney Docket No. 11-1-4, entitled EFFICIENCY OF USE OF A SHARED PRODUCT naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Aug. 31, 2011, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### SUMMARY

A system includes, but is not limited to, means for computing an ecological impact quantification associated with manufacturing at least a portion of a product according to product specification data associated with the product; and means for associating a device-readable indicator corresponding to the ecological impact quantification associated with manufacturing at least a portion of a product with a product manufactured at least partially according the product specification data.

A computer implemented method includes, but is not limited to computing an ecological impact quantification associated with manufacturing at least a portion of a product according to product specification data associated with the product; and associating a device-readable indicator corresponding to the ecological impact quantification associated with manufacturing at least a portion of a product with a product manufactured at least partially according the product specification data. In addition to the foregoing, other method aspects are described in the claims, drawings, and text forming a part of the present disclosure.

A computer-readable storage medium product includes, but is not limited to instructions for computing an ecological impact quantification associated with manufacturing at least a portion of a product according to product specification data associated with the product; and associating a device-readable indicator corresponding to the ecological impact quantification associated with manufacturing at least a portion of a product with a product manufactured at least partially according the product specification data. In addition to the foregoing, other computer-readable storage medium aspects are described in the claims, drawings, and text forming a part of the present disclosure.

A system includes, but is not limited to circuitry for computing an ecological impact quantification associated with manufacturing at least a portion of a product according to product specification data associated with the product; and circuitry for associating a device-readable indicator corresponding to the ecological impact quantification associated with manufacturing at least a portion of a product with a product manufactured at least partially according the product specification data. In addition to the foregoing, other system aspects are described in the claims, drawings, and text forming a part of the present disclosure.

A system includes, but is not limited to: means for computing an ecological impact quantification associated with disposal of at least a portion of the product according to a product disposal mode; and means for associating a device-readable indicator corresponding to the ecological impact quantification associated with disposal of at least a portion of the product according to a product disposal mode with the product.

A computer implemented method includes, but is not limited to: computing an ecological impact quantification associated with disposal of at least a portion of the product according to a product disposal mode; and associating a device-readable indicator corresponding to the ecological impact quantification associated with disposal of at least a portion of the product according to a product disposal mode with the product.

A system includes, but is not limited to: circuitry for computing an ecological impact quantification associated with disposal of at least a portion of the product according to a product disposal mode; and circuitry for associating a device-readable indicator corresponding to the ecological impact quantification associated with disposal of at least a portion of the product according to a product disposal mode with the product.

A computer-readable storage medium product stores instructions, including, but not limited to instructions for: computing an ecological impact quantification associated with disposal of at least a portion of the product according to a product disposal mode; and associating a device-readable indicator corresponding to the ecological impact quantification associated with disposal of at least a portion of the product according to a product disposal mode with the product.

In one or more various aspects, related systems include but are not limited to circuitry and/or programming for affecting the herein referenced aspects; the circuitry and/or programming can be virtually any combination of hardware, software, and/or firmware configured to affect the herein referenced method aspects depending upon the design choices of the system designer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows a high-level illustration of an operational environment.

FIG. 2 shows a high-level illustration of an exemplary system.

FIG. 3 shows a high-level illustration of an exemplary system.

FIG. 4 shows a high-level illustration of an exemplary system.

FIG. 5 shows an operational procedure.

FIGS. 5-17 show alternative embodiments of the operational procedure of FIG. 5.

FIG. 18 shows an operational procedure.

FIGS. 19-23 show alternative embodiments of the operational procedure of FIG. 18.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The consumption of rare materials and the ecological impact caused by human behavior are both becoming serious problems for the Earth. For example, some experts estimate that our use of the ecosystem to obtain food, timber, energy, exceeds the planet's ability to provide. As if the scarcity of resources was not enough of a problem, human behavior is also causing increasing amounts of greenhouse gasses to be emitted into the atmosphere. Certain greenhouse gasses, such as carbon monoxide, sulfur dioxide, chlorofluorocarbons (CFCs) and nitrogen oxides, are generated by manufacturing, using, and disposing of products and the general consensus is that these greenhouse gases cause harm to the environment. For example, according to the 2007 Fourth Assessment Report by the Intergovernmental Panel on Climate Change (IPCC), greenhouse gases have caused the global surface temperature increased 0.74±0.18 C (1.33±0.32 F) during the 20th century. Climate models project that the temperature will increase another 1.1 to 6.4 C (2.0 to 11.5 F) during the 21st century. It is likely that this increase in temperature is a significant problem for living creatures. For example, the living planet index, which is an indicator of the state of global biological diversity, shows that between the period of 1970 and 2003 biodiversity fell 30 percent.

While the demand for products is causing significant damage to the environment, most people are complacent. People generally indicate that they care about the environment; however, people typically do not act in an environment friendly way because they are not aware of how their actions truly affect the environment. One reason for this may be that impact is too abstract to appreciate. For example, a person may recognize that driving a car causes harm to the environment; however, the person may not appreciate how much harm it causes because the person does not have to face any immediate penalty for driving nor does the person have to perceive any recognizable link between their behavior and the damage caused.

Accordingly, robust methods, systems, and computer program products are provided to, among other things, bring about an operational system wherein users can perceive how consumption behavior affects the environment. In an exemplary embodiment, potential ecological impact associated with products can be quantized, e.g., mapped to a discrete set of numbers (−99 to 99), or mapped to an abstract scale, e.g., “awful,” “bad,” “neutral,” “good,” and “exceptional” to express the impact these products have had and/or will have on the environment. Potential-ecological-impact quantifications can be calculated for one or more stages of a product's lifecycle and/or for one or more disposal modes for the product. In at least one example embodiment, a user can perceive the potential-ecological-impact quantifications for a product (or information based at least in part on the quantifications) and understand how much estimated harm the product has caused to the environment (e.g., from the mere fact that it was created) and/or how much harm the product can potentially cause when it is disposed of. The potential-ecological-impact quantifications allow the user to make a determination as to whether he or she wants to use products that are harmful to the environment and/or how to dispose of products he or she owns.

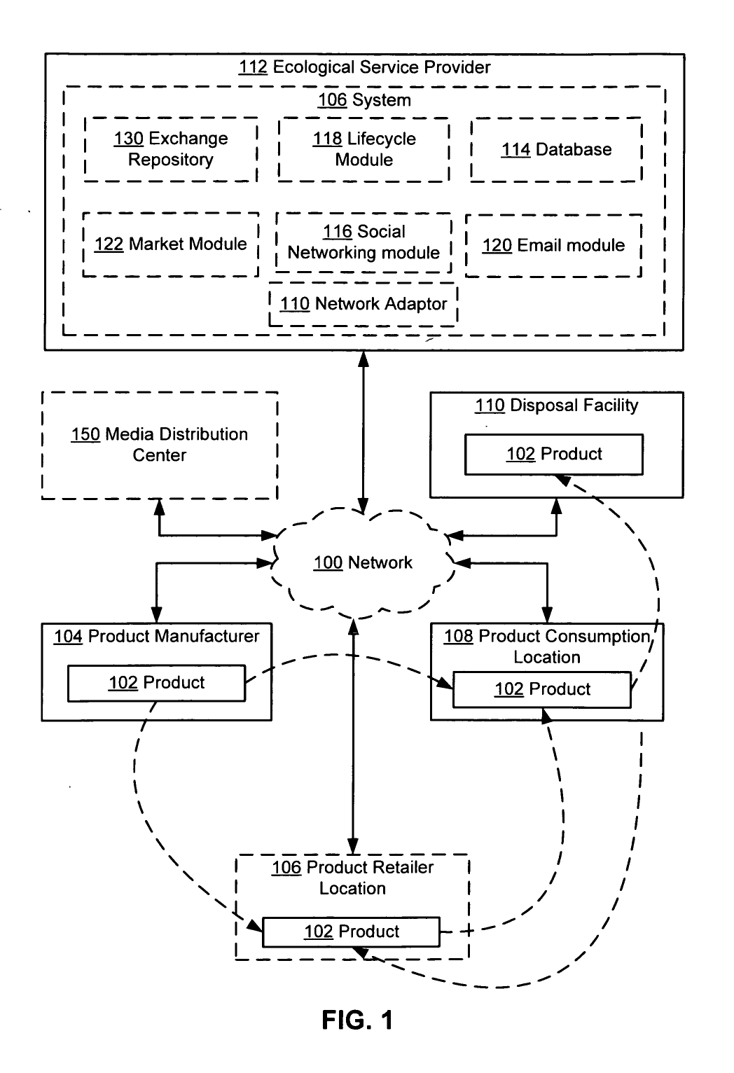

Referring now to FIG. 1, it illustrates a high-level block diagram of an exemplary operational environment that can be used to describe embodiments of the present disclosure. The arrows in dashed lines illustrate how product 102 can move through different locations throughout its life. The block-elements indicated in dashed lines are indicative of the fact that they are considered optional.

As an aside, each location within FIG. 1 can be interconnected via network 100, which may be the Internet. Each location can connect to network 100 using an access method such as, for example, a local area network (LAN), a wireless local area network (WLAN), personal area network (PAN), Worldwide Interoperability for Microwave Access (WiMAX), public switched telephone network (PTSN), general packet radio service (GPRS), cellular networks, and/or other types of wireless or wired networks.

FIG. 1 illustrates various points in the lifecycle of product 102, e.g., an appliance, vehicle, electronic device, food-services item, etc. At some point in time, product 102 can be manufactured by product manufacturer 104. For example, a company can purchase raw materials and/or manufactured materials and create product 102. After product 102 is manufactured, it can be optionally transported to product retailer 106 to be sold to a user (or sold directly to a user) and transported to product consumption location 108, e.g., a user's home. The user can use the product, resell product 102 to product retailer 106 (or another product retailer), donate product 102 (not shown), or sell product 102 to another user (not shown). Eventually, product 102 will be fully consumed, i.e., used up, broken, etc., and can be disposed of. Product 102 can be transported to a disposal facility 110, e.g., landfill, recycling facility, incineration facility, etc., where it can be disposed of.

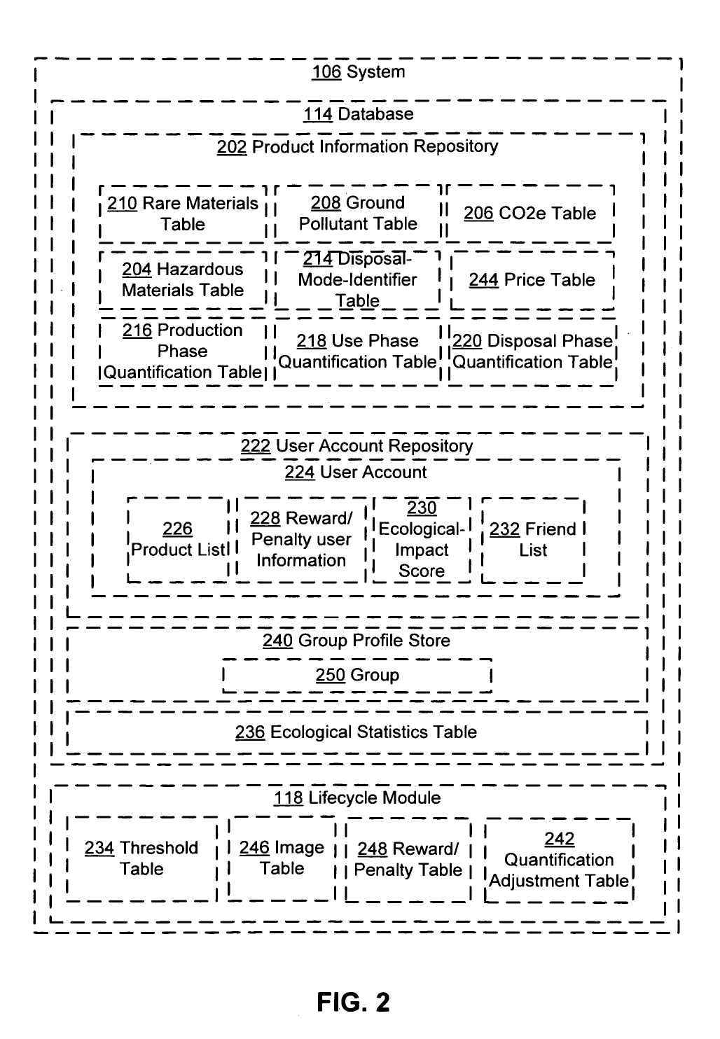

In an exemplary embodiment, ecological service provider 112 can be used generate potential-ecological impact quantifications and communicate them (or information based on them) to users at different points in the lifecycle of product 102. For example, ecological service provider 112 can include system 106, which can include one or more computer systems having processors, memory, operating system software, network adaptors, etc. As shown by the figure, system 106 can include database 114, which is described in more detail in FIG. 2 and the following paragraphs. Also shown by the figure is market module 122, which can store market data in exchange repository 130. Briefly, market module 122 can be configured to affect an online market place for the exchange of products. For example, market module 122 can generate one or more web-pages that can be sent to computing devices, e.g., computer systems, mobile phones, etc., that can be used to search for products, list products for exchange, and/or register for notifications for products. The lists of products for sale, offers for products, etc., can be stored in exchange repository 130, which can be effected by one or more databases.

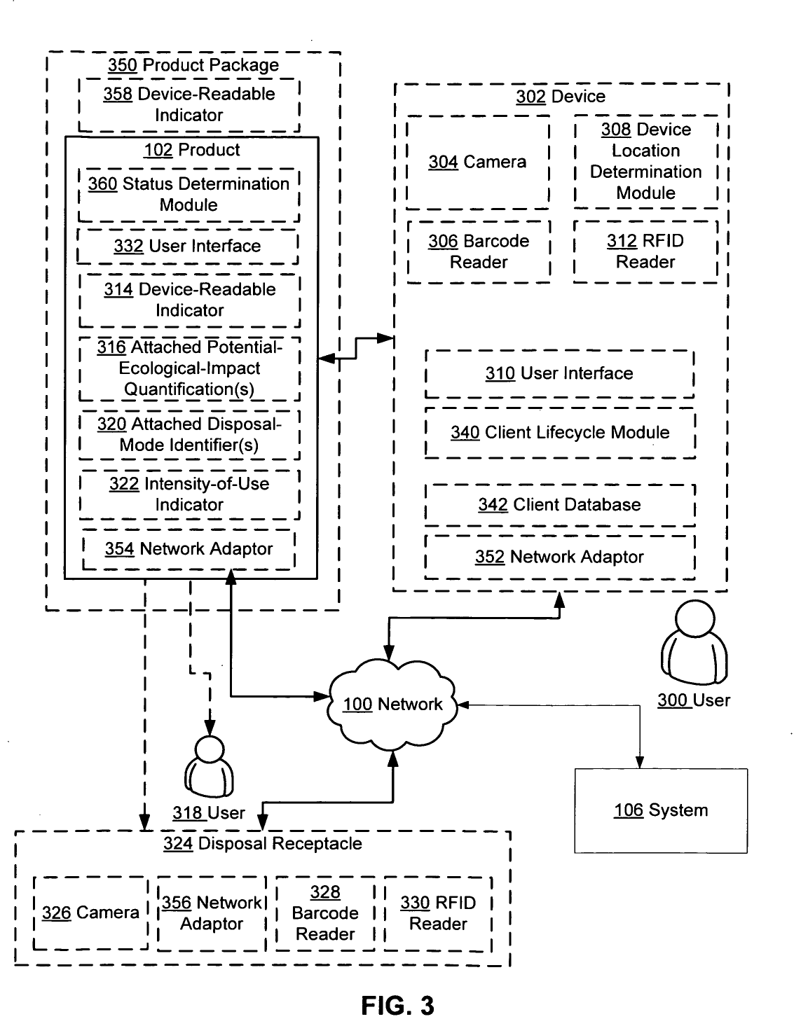

Continuing with the high-level overview of FIG. 1, system 106 can include social networking module 116 and/or email server 120. Briefly, social networking module 116 can be configured to generate one or more web-pages that can be sent to computing devices such as device 302 of FIG. 3, which is described in more detail in the following paragraphs. In an exemplary embodiment, the web-pages can allow users to create and manage user profiles and/or interact with other users that have created profiles. In the same, or another exemplary embodiment, the web-pages can be used to interface with a lifecycle module, which is described in more detail in the following paragraphs. Also shown is email module 120, which can affect an email system that can send emails to computing devices such as device 302 of FIG. 3. In an exemplary embodiment, the emails can contain various information such as offers to purchase products, rewards, potential-ecological-impact quantifications (described in more detail in the following paragraphs), etc.

Media distribution center 150 is also illustrated in FIG. 1. Media distribution center 150 can be maintained by the same organization that maintains server 106 or a separate entity. Generally, media distribution center 150 can be configured to receive; store; and/or disseminate information gathered by system 106. For example, media distribution center 150 can be configured to include a webserver, email server, short message service (“SMS”) server, television station, etc. In a specific example, media distribution center 150 can receive, store, and/or disseminate information that is at least based in part on ecological-impact scores (which are described in more detail in other paragraphs) for users. For example, media distribution center 150 could be an organization that allows users to create Internet-based journals, e.g., blogs. In this example, the blog could receive the ecological-impact score from, for example, device 302 or system 106. The ecological-impact score could then be stored within a webpage or document that is accessible via the blog.

System 106 also includes lifecycle module 118 (“LCM”) and database 114. As shown by FIG. 2, database 114 can include product information repository 202, which can include information for one or more products and user account repository 222, which can store user accounts for each user of the system. For example, each product can be assigned a device-readable indicator, which could be a unique alphanumeric value that can be used to identify the product within system 106. Each user account can also be assigned an alphanumeric value that can be used to identify the user account within system 106. Product information repository 202 can store product information for product 102 of FIG. 1 along with information for other products and user account repository 222 can store information for user account 224, which can be a user account for user 300 of FIG. 3. As one of skill in the art can appreciate, the information described as “within” database 114 can be stored in one or more physical databases in one more geographic locations and the disclosure is not limited to the illustrated configuration.

Product information repository 202 can include one or more collections of information gathered by an agent of ecological service provider 112 and/or by an agent of product manufacturer 104. In embodiments of the present disclosure, the collected data can be used to generate potential-ecological-impact quantifications, e.g., values such as 5 impact points or abstract values such as “good,” “average,” or “bad,” for at least one stage of a product's lifecycle, e.g., its production phase, use phase, and/or disposal phase, that can be stored in product information repository 202 in the appropriate section (namely, production phase quantification table 216, use phase quantification information 218, and/or disposal phase quantification information 220, the latter potentially including multiple quantifications for a product: one quantification for each disposal mode for a product.)

One type of data can be gathered and stored in rare materials table 210 is an itemized list of the materials that are used up and/or the materials that that a product is made from when it is manufactured. In at least one exemplary embodiment, data that identifies the rare materials that are in product 102 (and other products) and/or the rare materials that were consumed in the process of making product 102 can be used to generate one or more potential-ecological-impact quantifications. For example, an agent from ecological service provider 112 and/or product manufacturer 104 can obtain a breakdown of the components in product 102 and derive the amount of rare-earth materials and/or rare materials that were used to create product 102.

Rare materials can include rare-earth materials and/or materials that are simply scarce. For example, the International Union of Pure and Applied Chemistry has established a collection of chemical elements from the periodic table that are considered “rare-earths.” For the most part, these elements are not rare in the sense that they are not abundant, but that they are difficult to purify from their oxides. Rare-earth elements are essential components in modern electronics and demand is growing. For example, Cerium oxide, the lowest value rare earth, jumped 930 percent from 2007 to over $35 per kilogram in 2010. The rare-earth elements are Lanthanum (which can be used to create high refractive index glass, camera lenses, battery-electrodes), Cerium, Praseodymium, Neodymium, Promethium (which can be used to create nuclear batteries), Samarium, Europium, Gadolinium (which can be used to create computer memory), Terbium, Dysprosium, Holmium, Erbium (which can be used to produce vanadium steel), Thulium, Ytterbium, Lutetium, Actinium, Thorium, Protactinium, Uranium, Neptunium, Plutonium, Americium, Curium, Berkelium, Californium, Einsteinium, Fermium, Mendelevium, Nobelium, and Lawrencium.

Hazardous materials information for each product can be collected and stored in database 114 in, for example, hazardous materials table 204 and used to create one or more potential-ecological-impact quantification for products such as product 102. Hazardous waste can include waste that poses a substantial or potential threat to public health and/or the environment. The list of hazardous substances tracked and stored in hazardous materials table 204 may vary a bit from one country to another and can include, but is not limited to, substances that may explode when exposed to a flame or when shocked, substances that are highly flammable, etc., and/or substances that are toxic, corrosive, infectious, carcinogenic, etc.

Ground pollutant data can be stored in ground pollutant table 208 and used to create one or more potential-ecological-impact quantifications. Generally, ground pollutant data can include information such as the estimated amount of pollutants that are emitted by product manufacturer 104 (other than hazardous waste) when producing a product and/or the estimated amount of ground pollution generated by disposing of a product according to different disposal modes. In an exemplary embodiment, the ground pollutants tracked can include, but are not limited to, heavy metals, chlorinated hydrocarbons, led, zinc, benzene, etc. This type of typically enters the environment via landfills.

Carbon dioxide equivalent table 206 can include information about the greenhouse gases (i.e., normalized greenhouse gases expressed as carbon dioxide equivalent or CO₂e) that are associated with product 102. Greenhouse gasses are emitted in almost every stage of a product's lifecycle and in an exemplary embodiment, the amount of normalized greenhouse gasses that can be attributed to the production, use, and/or disposal of a product can be collected and used to generate one or more potential-ecological-impact quantifications. For example, an agent from ecological service provider 112 or product manufacturer 104 can measure the amount of electricity used by product manufacturer 104 and determine how much energy is used to manufacturer one product. The source of the energy can be determined from the power plant and the amount of CO₂e emissions generated by the power plant in order to produce the power used to acquire raw materials and manufacture a product can be captured and stored in CO₂e information 206.

The amount of CO₂e generated from power plants can be estimated from information obtained from the energy grid. For example, the power company that manages the grid can provide information that identifies the source of the energy, e.g., hydro-power, natural gas, coal, etc., and the CO₂e emissions with each energy source can be calculated as well as the percentage of energy generated from each source. In this example, the amount of CO₂e emissions that can be tied to the production of the energy needed to create product 102 can be captured and stored in CO₂e table 206.

The list of gasses can include the following and an amount of each gas can be multiplied by a scalar value, shown in parenthesis, in order to convert the gases (in metric tons) to CO₂e: carbon dioxide (1), methane (21), nitrous oxide (310), perfluorocarbons (2,300), hydrofluorocarbons (12,000), and sulfur hexafluoride (23,900). This shows that one million metric tons of methane and nitrous oxide is equivalent to emissions of 21 and 310 million metric tons of carbon dioxide. In an exemplary embodiment, information provided from the Environment Protection Agency (the “EPA”) can be used to estimate the amount of CO₂e associated with products. This information can be found in the report entitled “Inventory of U.S. Greenhouse Gas Emissions and Sinks: 1990-2005” and the EPA's report entitled “Solid Waste Management and Greenhouse Gases: A lifecycle Assessment of Emissions and Sinks,” 3^{rd} Edition September 2006, both of which are herein incorporated in their entirety.

In exemplary embodiments, some or all of the above mentioned data can be used to generate one or more potential-ecological-impact quantifications for one or more products. For example, an exemplary potential-ecological-impact quantification could be based at least in part on the amount of rare-materials associated with a product, the amount of hazardous waste associated the product, the amount of ground pollution associated with the product, and/or the amount of CO₂e associated with the product. For example, 60 kilograms of CO₂e may be emitted during the manufacturing process for a cellular phone. In an exemplary embodiment, this amount of CO₂e can be quantized along with the amount of rare materials in the cellular phone, the amount of hazardous waste and ground pollution created to make the cellular phone. The quantifications can then be combined, e.g., added, multiplied, etc., in order to create a potential-ecological-impact quantification.

Each potential-ecological-impact quantification can be categorized into groups for different stages of a product's lifecycle. For example, ecological-impact associated with a production phase can be stored in production phase quantification table 216. The other tables being use phase quantification table 218, and disposal phase quantification table 220. In an exemplary embodiment, a single product may be associated with a potential-ecological-impact quantification that is based on the potential harm to the environment caused by producing the product, a potential-ecological-impact quantification that is based on the potential harm caused by using the product, and potential-ecological-impact quantifications for the potential harm that could be caused by the different ways of disposing of the product. In another exemplary embodiment, a single potential-ecological-impact quantification can be generated that shows the cumulative ecological-impact caused by the product, e.g., the potential-ecological-impact quantification could be the sum of all of the aforementioned potential-ecological-impact quantifications for the different phases of the product's lifecycle.

In a specific example, production potential-ecological-impact quantifications can be based on the amount of rare-materials in a product or the amount of rare-materials that were consumed to create a product. In this example, the quantification process can use the price of the rare-material and/or the amount of the rare-material in product 102 when generating a potential-ecological-impact quantification. For example, a kilogram of a less valuable rare-earth material such as cerium oxide could be mapped to a materials-score of 1 where as a kilogram of praseodymium (a more expensive rare-earth) can be mapped to a potential-ecological-impact quantification of 9. The materials potential-ecological-impact quantification can optionally be combined with other potential-ecological-impact quantifications to create a production potential-ecological-impact quantification.

In addition to rare-materials, a production potential-ecological-impact quantification can be based on the amount and type of hazardous waste that was created to produce a product. For example, a high amount of a dangerous type of hazardous waste can be mapped to a high potential-ecological-impact quantification. This potential-ecological-impact quantification can optionally be combined with other potential-ecological-impact quantifications to create production potential-ecological-impact quantification.

In yet another embodiment, a production potential-ecological-impact quantification can be based on the amount of CO₂e generated to create a product. For example, CO₂e is typically emitted during this phase in order to generate the energy to transport raw/manufactured materials to product manufacturer 104 and the energy needed to assemble the materials into the product. In this example, the amount of CO₂e generated to build one product can be estimated and mapped to a CO₂e-based potential-ecological-impact quantification. For example, low amounts of CO₂e can be mapped to low CO₂e-based potential-ecological-impact quantifications and high amounts of CO₂e can be mapped to high CO₂e-based potential-ecological-impact quantifications. A CO₂e-based potential-ecological-impact quantification can then be combined with one or more other potential-ecological-impact quantifications to obtain a production phase potential-ecological-impact quantifications.

CO₂e emissions associated with acquiring raw materials and manufacturing product 102 can include energy consumed to obtain raw materials, manufacturer products, manage the corporation, and dispose of waste. In general, the majority of energy used for these activities is derived from fossil fuels burned to operate mining equipment, fuel blast furnaces, etc., and to generate electricity to power machines used during the manufacturing stage.

Use phase potential-ecological-impact quantifications can reflect the potential harm caused to the environment due to the transporting, storing, and actually using a product. The majority of the ecological impact in this phase can be attributed to CO₂e emissions associated with the power used by a product, and/or the CO₂e emitted by product as it operates, e.g., a vehicle. Food services products may require refrigeration, which requires electricity that is associated with CO₂e emissions. Most cold storage facilities operate at a wide range of temperatures. In an exemplary embodiment, an average temperature can be estimated along with an average size of a storage facility and the average amount of energy used to refrigerate a product, which may be a six pack of beer. This information along with the volume of the product can be used to estimate the CO₂e emissions caused by storing the product in a refrigerated facility. The CO₂e emissions can be used to generate a use phase potential-ecological-impact quantification, which can be stored in use phase quantification table 218.

Similar to the aforementioned potential-ecological-impact quantification associated with transportation and/or storage, a potential-ecological-impact quantification associated with operating the product can be calculated from mostly the CO₂e emitted in order to generate the power for a product and/or the CO₂e emitted by the product as it is running. This data can be gathered for product 102; stored in CO₂e table 206; and used to generate a CO₂e based use phase potential-ecological-impact quantification. For example, any product that consumes electricity most likely causes harm (even if it is indirect harm) to the environment due to the fact that the power it consumes likely comes from a source of energy that generates CO₂e.

When a user is finished with a product (when it is at the end of its life for example) it can be disposed of. In an exemplary embodiment, disposal phase potential-ecological-impact quantifications can be based on one or more of the amount of rare materials lost due to disposing of a product, the amount of CO₂e emitted when disposing of a product (either from the product or from the equipment used to dispose of the product), the amount of hazardous waste that product emits during disposal, the amount of ground pollution generated by disposing of a product, etc. In an exemplary embodiment, each disposal phase potential-ecological-impact quantification can be associated with a disposal-mode-identifier stored in disposal-mode-identifier table 214. The disposal-mode-identifier can be associated with information that describes how to dispose of the product according to a disposal mode. For example, a recycling disposal-mode-identifier could be associated with text that provides the address of a recycling facility or a map to the recycling facility. In another specific example, an incineration disposal-mode identifier can include audio describing which type of disposal receptacle, e.g., trash can, dumpster, etc., the product should be placed in to have it incinerated.

Since a product can be disposed of in different ways, each product can be associated with multiple disposal potential-ecological-impact quantifications. An exemplary, non-exhaustive list of disposal modes can include reselling (and/or donating, trading, etc), recycling, composting, incinerating, landfilling, etc. Thus, in an exemplary embodiment a product can be associated with one or more potential ecological impact quantification for each disposal mode that is available to a product. For example, a product such as a mp3 player may have available modes that include a reselling mode, a recycling mode, and a landfilling mode.

In an exemplary embodiment, a product can be associated with a resell disposal mode. In this exemplary embodiment, the potential-ecological-impact quantification associated with reselling the product can be based on an estimated amount of CO₂e used to transport the product from one user to the next user. In some instances, the CO₂e may be negligible.

In an exemplary embodiment, a product can be associated with a potential-ecological-impact quantification associated with a recycling disposal mode. In an exemplary embodiment, the potential-ecological-impact quantification for recycling can be based on, for example, the amount of CO₂e associated with generating the power used to disassemble the product, the amount of rare materials that are lost during the recycling process, etc. Since recycling a product involves disassembling the product and using parts of it in other products, products made from a recycled product may have lower production phase potential-ecological-impact quantifications than similar products made from virgin materials.

Composting is another disposal mode and a potential-ecological-impact quantification for composting a product can be generated. Composting is the process of disposing of organic material by way of aerobic decomposition. For example, composing may result in CH₄ emissions from anaerobic decomposition and N₂O may be released by the soil after compost is applied to the ground, however these emissions are essentially zero. Composing has an additional benefit of capturing carbon and can be used to enrich soils. Disposal by sequestration is another technique used to reduce the amount of carbon that escapes into the environment. The EPA estimates composting/sequestering reduces the amount of CO₂e emitted by 0.05 metric tons of CO₂e per ton of compost. In an exemplary embodiment, the information can be used to generate a composing CO₂e-based potential-ecological-impact quantification for products that can be composted. In some instances, this potential-ecological-impact quantification could reduce the harm caused to the planet.

Another disposal mode is incineration. Incineration involves the combustion of organic substances within waste materials thereby converting the waste into ash, heat, and flue gases, which may contain significant amounts of particulate matter, heavy metals, dioxins, furans, sulfur dioxide, and hydrochloric acid, and/or CO₂. Municipal solid waste (“MSW”) contains approximately the same mass fraction of carbon as CO₂ itself (27%), so incineration of 1 ton of MSW produces approximately 1 ton of CO₂. In an exemplary embodiment, the amount of CO₂e emitted by incineration, the amount of CO₂e generated in order to power the incineration facility, the amount of hazardous waste generated, etc., can be gathered; and used to create a potential ecological impact quantification for disposing of a product according to an incineration mode of disposal. Similar to incineration, waste can evaporated by storing liquids in evapo-transpiration beds or mechanical evaporation units and potential-ecological-impact quantifications can be developed that reflect the harm to the environment caused by evaporating liquid products.

A disposal mode for a product could include sending the product to a landfill. During solid-waste landfill operations, waste collection vehicles transport the waste materials to a tipping face or working front where they unload their load. After loads are deposited, compactors or dozers can be used to spread and compact the waste on the working face and the compacted waste can be covered with soil daily.

Landfills cause a number of problems for the environment such as pollution by the contamination of groundwater and soil and the gasses released by decaying organic material. The CO₂e emissions of a landfill are mostly due to methane emissions, transportation related carbon dioxide emissions, and carbon storage resulting from landfilling organic waste and solid waste. Metals do not contain carbon and do not generate CO₂e emissions, however they could cause ground pollution. For example, salt, nitrates, led, copper, nickel, cadmium, etc., are different materials that can cause ground pollution. Plastics do not biodegrade and therefore do not emit greenhouse gases. This information can then be used to create a landfill potential-ecological-impact quantification.

Ocean floor disposal is another disposal method. This technique involves depositing waste, e.g., radioactive waste, in ocean floor sediment. Exemplary techniques for depositing waste involve encasing the waste in concrete or in a shaft drilled into the bottom of the ocean. Potential-ecological-impact quantifications can be created that take into account the potential-ecological harm caused by depositing waste in the ocean.

In addition to storing potential-ecological-impact quantifications, in an exemplary embodiment, database 114 can also maintain user accounts. The user accounts can be tied into a social network where users can blog, post pictures, send message to each other, etc. Social networking module 116 can be configured to generate one or more web-pages that can be downloaded to computing devices, e.g., table personal-computers, smart phones, etc., that include logic operable to allow users to interact with each other. For example, social networking module 116 can send web-pages to computing devices that allow users to blog, post pictures, etc. User account 224 is illustrated, which can be associated with user 300 (while one user account is shown, system 106 can maintain accounts for a plurality of users).

In addition to the foregoing, each user account, such as user account 224 can include a product list 226, which can contain a listing of products associated with user account 224. For example, product list 226 can be a running list of products that have been associated with user account. Each product the user has purchased can be listed along with its status, e.g., active or disposed of, the disposal method selected to dispose of the product, how long the product has been associated with the user account, a unique serial number for the product (which can be used to associate specific instances of a product with a specific user), etc.

Continuing with the description of FIG. 2, reward/penalty information 228 can include data indicative of the reward/penalty user 300 has earned due to his or her product purchasing and/or disposal behavior. For example, a reward stored in reward/penalty information 228 could include an icon indicative of a trophy created by an organization committed to acting in an environmentally friendly way. In another embodiment, reward/penalty information 228 could include a graphic indicative of a coupon, a gift certificate, information indicating free or reduced services given to user 300, etc. Similarly, reward/penalty information 228 can include penalties associated with user account 224 based on disposal and/or product purchasing behavior. For example, a penalty could be a fee charged to user 300, a trophy with a negative association, etc.

Each user account can also be associated with an ecological-impact score, which can be based in part on a user's estimated impact on the environment. In a specific example embodiment, an ecological-impact score can be a running score of the potential-ecological-impact quantifications associated with the user account. For example, suppose a user has an estimated impact score of zero points and purchase a mobile phone with a potential-ecological-impact quantification due to producing the mobile phone of 4 impact points. The user uses the mobile phone for three years and accumulates 5 impact points from charging the mobile phone over the years. After the three years user may throw the mobile phone out in a landfill and cause 3 impact points. The total potential-ecological impact for the mobile phone could be 12 impact points. In this specific example, the ecological-impact score for the user could be 12 impact points.

In another embodiment, potential-ecological-impact quantifications may be one factor used to calculate an ecological-impact score. In this specific example, the ecological-impact score can be adjusted by the amount of environmentally friendly activities the user undertakes, e.g., by purchasing carbon credits or performing other activities that have a positive effect on the environment. In another exemplary embodiment, the ecological-impact score can be adjusted based on how a user uses a product. For example, a user that purchases a car and drives it once a month is not efficiently using the vehicle and a better decision would have been for the user to take public transportation or join a car-sharing group such as Zipcar®. In this specific example, information that describes how intensely the product has been used could negatively/positively affect the user's ecological-impact score. In another exemplary embodiment, the ecological-impact score can be adjusted based on a group the user is a member of. For example, a user could be part of a “Green” group that sets requirements for how long products should be used before disposal. In this example, the user's compliance/noncompliance rate can affect his or her ecological-impact score.

Turning back to user account 224, a user account can have a friends list 232, which links user account 224 to other user accounts. Also shown is ecological statistics table 236, which can include information such as the number of times a user has selected an incineration mode of disposal vs. recycling or reselling mode of disposal, how user 300 compares to other users on his or her friends list, etc.

System 106 is also shown as including lifecycle module 118. For example, and described in more detail in the following paragraphs, lifecycle module 118 can be configured to generate an ecological-impact score for a user account, determine whether to display disposal mode indicators, (which are described in more detail in the following paragraphs), and/or search for various information within database 114, etc.

As shown by the figure, in an exemplary embodiment lifecycle module 118 can be associated with tables of information, which can be used in exemplary embodiments of the present disclosure to configure lifecycle module 118. Briefly, the tables can include, but are not limited to, threshold table 234, quantification adjustment table 242, image table 246, and/or reward/penalty table 248. Briefly, image table 246 can include images of products that can be associated with device-readable indicators. In an exemplary embodiment, products may not include device-readable indicators and LCM 118 can determine indicators from images. Quantification adjustment table 242 can include adjustment-quantifications that can be used to adjust ecological-impact scores based on certain criteria that will be described in more detail in the following paragraphs. Reward/penalty table 248 can include a list of rewards, e.g., positive rewards and penalties, which can be associated with a user account based on certain criteria described in more detail in the following paragraphs.

Group profile store 240 can be used to store information about one or more groups such as group 250, which user 300 may be a member of in an exemplary embodiment. A group can store information such as a group policy, which includes various criteria that can be used to adjust ecological-impact scores, reward users, etc. For example, a group policy can include a disposal timetable for a product or a type of product. The timetable can be used to determine whether a user has owned a product for an acceptable length of time before disposing of it according to disposal mode that causes harm to the environment. In a specific example, suppose product 102 is a mp3 player, and group profile 250 includes a list of acceptable disposal modes for the mp3 player, each of which is associated with a time-value. Also suppose that a user wants to dispose of the mp3 player by sending it to a landfill. In this example, a time-value for landfilling the mp3 player is 5 years. In this example, suppose a landfill disposal mode was selected for the mp3 player in year 3 of its existence. In this example, LCM 118 can calculate the amount of time the mp3 player has existed and compare it to the time-value. In this example, LCM 118 can determine that the mp3 player has been owned less than the time-value and generate an adjustment-quantification. For example, the adjustment-quantification could be 2, which indicates that the mp3 player is being disposed of 2 years early. LCM 118 can combine the adjustment-quantification with the potential-ecological-impact quantification for disposing of the mp3 player via a landfill and add the result to ecological-impact score.

Turning now to FIG. 3, it generally illustrates an exemplary environment, which could be product retailer location 106, product consumption location 108, or disposal facility 110. The dark dashed arrows indicate that product 102 could be optionally disposed of by placing product 102 in disposal receptacle 324, e.g., a recycling bin or trash, or given to another user such as user 318. Of course, in an exemplary embodiment where product comes in package 350, package 350 can also be given to user 318 or placed in disposal receptacle 324.

Device 302 may be a computing/communication device including, for example, a cellular phone, a personal digital assistant (PDA), a laptop, a desktop, or other type of computing/communication device. In an exemplary embodiment, device 302 may be a handheld device such as a cellular telephone, a smart phone, a Mobile Internet Device (MID), an Ultra Mobile Personal Computer (UMPC), a convergent device such as a personal digital assistant (PDA), and so forth. For example, device can include memory, e.g., random access memory, ROM, etc., that can contain executable instructions that can be executed by a processor. In addition, device 302 can include various integrated circuits such as GPS radios, network interface adaptors, etc., and the associated firmware that operates such devices. Device 302 can include user interface 310, which could include, but is not limited to, input components implemented by a combination of hardware and software such as a touch user interface, a keypad, a directional pad, a microphone, etc., and output components such as a screen, e.g., an liquid crystal display, a speaker, etc.

Device 302 can optionally include client database 342 and client lifecycle module 340. Device 302 can also include a network adaptor 352, which can be used to access network 100 and allow device 302 to communicate with ecological service provider 112. In an exemplary embodiment, client database 342 can include some or all of the data in database 114. For example, client database 342 can be configured to include a copy of user account 224, a copy of product information repository 202, a portion of product information repository 202 (the portion relating to products stored in product list 226), etc. Lifecycle module 340 can be a client side component that can perform some or all of the functions that LCM 118 can perform and/or Lifecycle module 340 can act as an interface to route information to LCM 118. An implementer may configure LCM 340 to perform certain functions and LCM 118 to perform others.

User 300 can optionally use device 302 to obtain ecological information about product 102 such as potential-ecological-impact quantifications. For example, product 102 can include memory, e.g., a barcode, random access memory, read-only memory, etc., which can be used to store information that can be used by device 302 to obtain information based off potential-ecological-impact quantifications and/or the potential-ecological-impact quantifications themselves, among other things.

As shown by the figure, product 102 can optionally include device-readable indicator 314, which can be information that can be extracted by device 302 in order to identify product 102. Device-readable indicator 314 could be an alphanumeric value, which can be stored in memory, e.g., RAM or ROM, in a barcode, in an RFID tag, or etched into product 102. In an exemplary embodiment, device-readable indicator 314 can be stored with a unique serial number that also identifies the specific instance of product 102. Device 302 can obtain device-readable indicator 314 by communicating with product 102 and/or extracting it from product 102 using a barcode reader 306, RFID reader 312, network adapter 352, or camera 304. In other exemplary embodiments, product 102 may not have an attached device-readable indicator, instead device-readable indicator 314 can be looked up from an image of product 102, audio of a user speaking about product 102, or from user input.

In an exemplary embodiment, a potential-ecological-impact quantification can be attached to product 102 in attached potential-ecological-impact quantification(s) 316. In this example, device 302 may be able to obtain one or more potential-ecological-impact quantifications from product 102 instead of from database 114 or client database 342. Similar to the aforementioned device-readable indicator 314, attached potential-ecological-impact quantification(s) 316 can be stored in memory, a barcode, an RFID tag, and/or etched onto product 102. In an exemplary embodiment where product 102 does not include attached potential-ecological-impact quantifications, LCM 118 or 340 can be used to obtain device-readable indicator 314, which can be used to search database 114 or 342 for potential-ecological-impact quantifications, among other things.

In yet another embodiment, product 102 may have one or more attached disposal mode identifiers 320. Disposal mode identifiers can include instructions, e.g., text, audio, images, for disposing of product according to a disposal mode, e.g., incineration, recycling, landfilling, etc. Similar to the aforementioned device-readable indicators, a disposal mode identifier may not be attached to product 102. Instead, this information could be stored within database 114 and/or client database 342.

In an exemplary embodiment, user 300 can use device 302 to obtain potential-ecological-impact quantifications for product 102 so he or she can learn about the potential-ecological impact associated with product 102. For example, suppose user 300 is interested in purchasing product 102, which could be a car, and may want to know the potential-ecological impact the car had on the environment by being produced. In this specific example, user 300 may obtain the potential-ecological impact the car had on the environment by using camera 304, e.g., a video camera and/or a still image camera, to take at least one picture of product 102. The one or more pictures can be processed by lifecycle module 340 and/or LCM 118 and device readable indicator 314 can be obtained by lifecycle module 340 and/or LCM 118. For example, the image can be compared to other images stored in image table 246 and a match can be made.

Alternatively, an RFID (radio frequency identifier) tag can be attached to the car and device-readable indicator 314 can be stored therein. In this exemplary embodiment, device 302 can include RFID reader 312, which can be configured to obtain device-readable indicator 314 from the car. Device-readable indicator 314 could then be used by LCM 118 and/or LCM 340 to search a database such as database 114 and/or client database 342.

In another specific example embodiment, suppose a network adaptor 354 is attached to the car. In this exemplary embodiment, device-readable indicator 314 can be stored in memory, e.g., RAM, ROM, etc. In this specific example, a point-to-point connection, e.g., via Bluetooth®, or a network connection, e.g., Wi-Fi, GSM, Wi-Max, etc., can be established between device 302 and product 102. The car can send information indicative of device-readable indicator 314 to device 302 within one or more packets of information via network adaptor 354. Network adapter 352 of device 302, e.g., a Wi-Fi radio, can receive the packets and extract device-readable indicator 314. Device-readable indicator 314 could then be used by LCM 118 and/or LCM 340 to search a database such as database 114 and/or client database 342.

Regardless of how device-readable indicator 314 is obtained, device 302 can use device-readable indicator 314 to obtain one or more potential-ecological-impact quantifications for the car in the instance that the car does not have attached potential-ecological-impact quantification(s) 316. For example, suppose device 302 includes LCM 340, which can interact with LCM 118 and does not include a client database in this specific example. Here, LCM 340 could request at least one potential-ecological-impact quantification associated with the production of the car from database 114 by sending device-readable indicator 314 to LCM 118, which can use device-readable indicator 314 to search production phase quantification table 216 for a potential-ecological-impact quantification associated with producing the car. For example, LCM 118 can receive a message which includes information such as a user account identifier for user account 224, device-readable indicator 314, and a value indicative of a request for a production potential-ecological-impact quantification for the product associated with device-readable indicator 314, i.e., the car. LCM 118 can receive the message and use device-readable indicator 314 to find a production potential-ecological-impact quantification for the car. LCM 118 can then send the potential-ecological-impact quantification to LCM 340 via network 100. In this example, LCM 340 can cause user interface 310 to render a bitmap in memory indicative of the potential ecological impact quantification. User interface 310 can then render the bitmap to a display.

Turning back to FIG. 3, at the end of a product's life it can be disposed of. In an exemplary embodiment, user 300 may want to know how to dispose of product 102 and how disposing of product 102 may affect the environment. In this example, user 300 may use user interface 310 to indicate to device 302 that he or she would like to dispose of product 102. Lifecycle module 340 could receive user input and obtain device-readable indicator 314. Client database 342 and/or database 114 can be searched and a disposal mode identifier and/or a potential-ecological-impact quantification can be found. User interface 310 can then display a disposal mode identifier and/or a potential-ecological-impact quantification. In another specific example, LCM 340 could extract a disposal mode identifier from attached disposal-mode identifier(s) 320 and/or a potential-ecological-impact quantification from attached potential-ecological-impact quantification(s) 316 in response to user input indicative of a request to dispose of product 102.

Product 102 can then be disposed of by user 300 by placing product 102 within a disposal receptacle 324. In an exemplary embodiment, disposal receptacle 324 can detect product 102 (by extracting a device readable indicator from product 102 and/or or passively inferring the presence of product 102 within disposal receptacle 324, e.g., by taking a picture of product 102). Disposal receptacle 324 can use network adaptor 356 to send device-readable indicator 314 to Lifecycle module 340 or LCM 118. Client database 342 and/or database 114 can be searched and a disposal mode identifier and/or a potential-ecological-impact quantification can be found. User interface 310 can then display a disposal mode identifier and/or a potential-ecological-impact quantification.

In another example, product 102 can be placed in disposal receptacle 324 and taken to disposal facility 110. In this example, an agent of disposal facility could extract device-readable indicator 314 and optionally the serial number of product 102 and send a message to LCM 118 that includes the serial number, device-readable indicator 314, and the identity of disposal facility 110. LCM 118 can use device-readable indicator 314 to find one or more disposal modes for product in disposal mode identifier table 214 and send the information back to disposal facility 110. The agent can then select one of the disposal modes. LCM 118 can then use the serial number to identify the user account that is associated with product 102 and update product list 226 to reflect that product 102 was disposed of by the disposal mode selected by disposal facility.

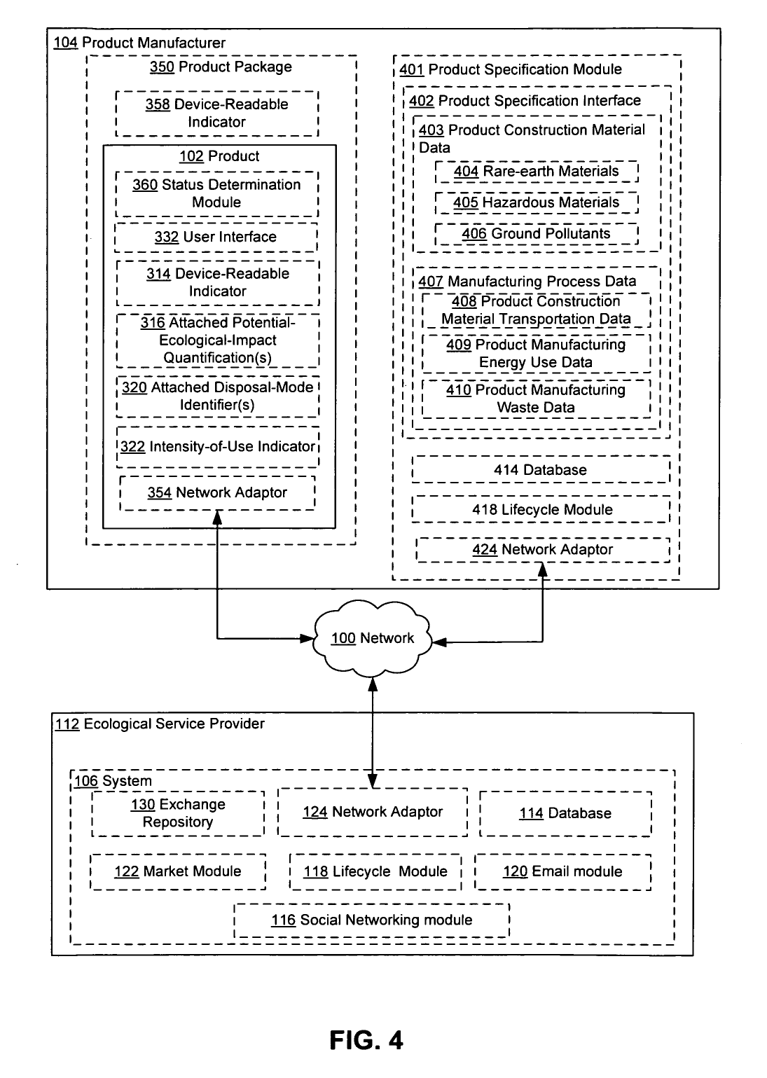

Turning now to FIG. 4, FIG. 4 generally illustrates an exemplary environment, which could be product manufacturer location 104 where a product 102 may be manufactured. As noted above, it may be desirable to determine the materials used in the construction of product 102 (e.g. rare earth elements, hazardous materials, etc.) as well various other ecological impact factors associated with the construction of the product 102 (e.g. energy use, waste, etc.) in order to characterize the complete ecological impact quantification of the manufacturing of the product 102 to allow for relative comparisons of the efficiency or non-efficiency of the associated manufacturing process.

It may be the case that, while a manufacturer of the product 102 may be aware of manufacturing specification data directly associated with the manufacturing process for product 102 (e.g. amount of materials used to construct the product, travel distances from vendor locations to the manufacturing location 104, manufacturing process parameters (e.g. process temperatures, pressures, residence times), etc.), the manufacturer may be unaware of the actual ecological impact of that manufacturing specification data. To that end, as shown in FIG. 4, a product specification module 401 may be provided at the manufacturing location 104. The product specification module 401 may be a software, hardware and/or firmware module configured to receive product specification data associated with the manufacturing of a product 102. Specifically, the product specification module 401 may be a client web application associated with a host server system maintained by the ecological service provider 112. The product specification module 401 may further include a database 414, LCM 418 and network adapter 424 configured to provide functionality as described above with respect to database 114, LCM 118 and network adapter 124 of system 106 of the ecological service provider 112. Such components may provide the functionality of remote system 106 at a location local to product manufacturer 104.

The product specification module 401 may further provide a product specification interface 402. The product specification interface 402 may present one or more data entry fields to a user allowing for the entry of product specification data associated with the manufacturing of a product 102. For example, the product specification interface 402 may be configured to receive product specification data such as product construction material data 403 (e.g. rare-earth material data 404, hazardous material data 405, ground pollutant data 406, etc.) and/or product manufacturing process data 407 (e.g. product construction material transportation data 408, product manufacturing energy use data 409, product manufacturing waste data 410).

Following receipt of the product specification data by the product specification module 401, an ecological impact quantification may be computed from the product specification data. For example, the product specification module 401 may provide the product specification data associated with the manufacturing of a product 102 to at least one of an LCM 118 associated with the product specification module 401 (i.e. local to the product manufacturing location 104) and the LCM 118 associated with the ecological service provider 112. The LCM 116 of the product specification module 401 and/or the ecological service provider 112 may access database 114 or database 414 respectively to obtain ecological-impact quantification data associated product specification data associated with the manufacturing of a product 102.

For example, the product specification data may include data indicative of the mileage between a raw material supplier and the product manufacturing location 104. The LCM 116 may obtain a CO₂e value associated with transporting a designated raw material the specified mileage from CO₂e table 206 of the database 114/414 and correlate that CO₂e value to ecological-impact quantification data maintained in production phase quantification table 216 to compute an ecological-impact quantification associated with the mileage between a raw material supplier and the product manufacturing location 104.

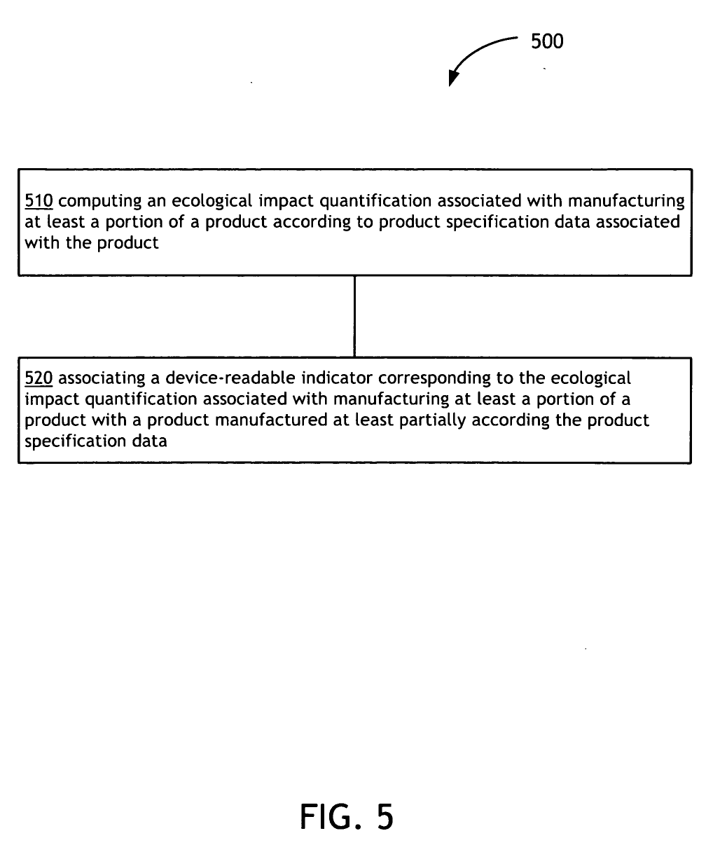

In FIG. 5 and in the following figures that include various examples of operational flows, discussions and explanations may be provided with respect to the above-described exemplary environment of FIGS. 1-4. However, it should be understood that the operational flows may be executed in a number of other environments and contexts, and/or in modified versions of FIGS. 1-3. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

FIG. 5 illustrates an operational procedure 500 including operations 502 and 504.

Operation 502 shows computing an ecological impact quantification associated with manufacturing at least a portion of a product according to product specification data associated with the product. For example as shown in FIGS. 1-4, the product specification module 401 may receive product specification data (e.g. user inputs from designers, process engineers, business executives) defining one or more manufacturing characteristics associated with a product 102 (e.g. construction materials, materials transportation data, energy use associated with product manufacturing). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with the product specification data for the product from the product information repository data maintained in database 114/414.

For example, the product specification data may include raw materials used in the manufacture of product 102. The LCM 118/418 may query the hazardous materials table 204 of database 114/414 to determine if any of the raw materials are classified as hazardous materials. Upon a determination that one or more raw materials constitute the LCM 118/418 may compare the amount of raw material classified as hazardous materials to a threshold amount of hazardous materials maintained in threshold table 234. Should the amount of raw material classified as hazardous materials be below the threshold amount of hazardous materials, it may be indicative of a reduced ecological impact associated with the manufacturing of the product 102. Should the amount of raw material classified as hazardous materials be above the threshold amount of hazardous materials, it may be indicative of an increased ecological impact associated with the manufacturing of the product 102. The LCM 118/418 may compute an ecological impact quantification according to the comparison between the amount of raw material classified as hazardous materials and the threshold amount of hazardous materials. For example, an amount of raw material classified as hazardous materials below the threshold amount of hazardous materials may be mapped to a ecological impact quantification of “1”, an amount of raw material classified as hazardous materials substantially equal to the threshold amount of hazardous materials may be mapped to a ecological impact quantification of “2” and an amount of raw material classified as hazardous materials above the threshold amount of hazardous materials may be mapped to a ecological impact quantification of “3.”

In an alternate example, the product specification data may include data associated with the transportation of quantity raw materials used in the manufacture of product 102. The LCM 118/418 may query the CO₂e table 206 of database 114/414 to determine the CO₂e value associated with transporting an amount of raw material a given distance. Upon a determination of the CO₂e value associated with transporting an amount of raw material a given distance, LCM 118/418 may compare the CO₂e value to a threshold CO₂e value maintained in threshold table 234. Should the CO₂e value associated with transporting an amount of raw material the given distance be below the threshold CO₂e value, it may be indicative of a reduced ecological impact associated with the manufacturing of the product 102. Should the CO₂e value associated with transporting the amount of raw material the given distance be above the threshold CO₂e value, it may be indicative of an increased ecological impact associated with the manufacturing of the product 102. The LCM 118/418 may compute an ecological impact quantification according to the comparison between the CO₂e value associated with transporting the amount of raw material the given distance and the threshold CO₂e value. For example, a CO₂e value associated with transporting the amount of raw material the given distance below the threshold CO₂e value may be mapped to a ecological impact quantification of “1”, a CO₂e value associated with transporting the amount of raw material the given distance equal to the threshold CO₂e value may be mapped to an ecological impact quantification of “2” and a CO₂e value associated with transporting the amount of raw material the given distance above the threshold CO₂e value may be mapped to a ecological impact quantification of “3.”

Following computation of ecological impact quantifications associated with various product specification data types, those individual ecological impact quantifications may be aggregated (e.g. summed, averaged, weighted average) to provide an overall ecological impact quantification for the manufacture of the product.

Operation 504 shows associating a device-readable indicator corresponding to the ecological impact quantification associated with manufacturing at least a portion of a product with a product manufactured at least partially according the product specification data. Following the computation of the ecological impact quantification associated with manufacturing at least a portion of a product 102 according to product specification data (e.g. construction materials, materials transportation data, energy use associated with product manufacturing, etc.) received via the product specification module 401, the ecological impact quantification may be associated with (e.g. encoded as, stored in, mapped to) a device-readable indicator 314. For example, the ecological impact quantification could be mapped to a device-readable indicator 314 (e.g. a numerical value) stored in an RFID-type device affixed to the product 102. Device 302 can obtain device-readable indicator 314 by communicating with product 102 and/or extracting it from product 102.

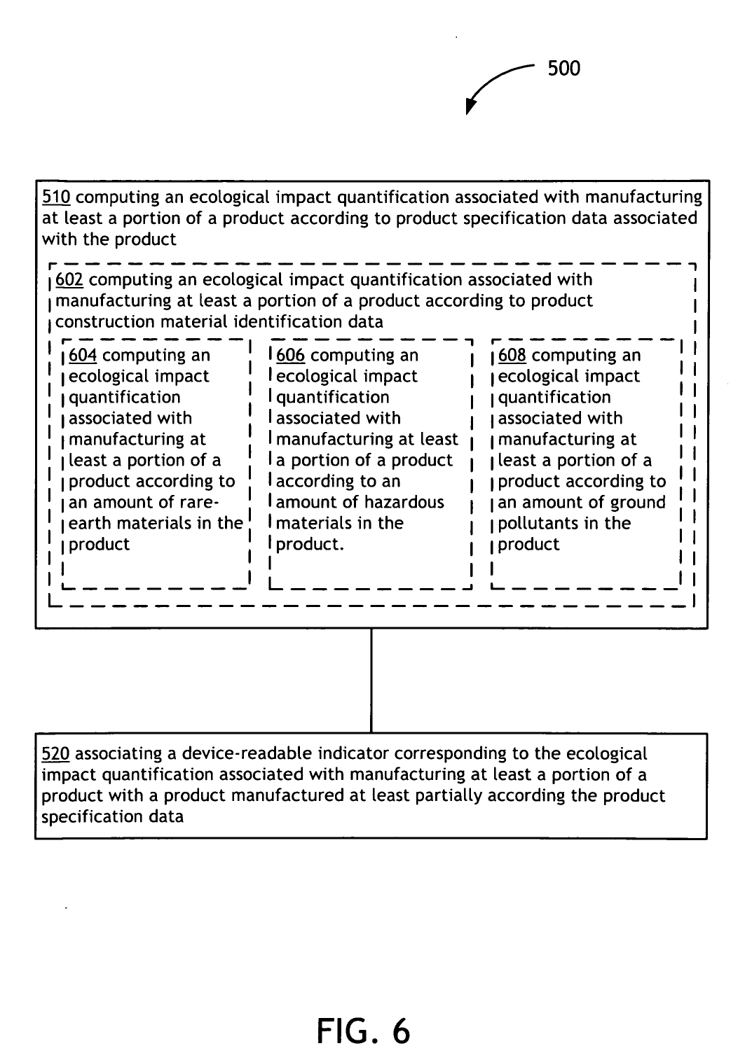

FIG. 6 illustrates an example embodiment where operation 502 of the example operational flow 500 of FIG. 5 may include at least one additional operation. Additional operations may include an operation 602, 604, 606 and/or 608.

Operation 602 shows computing an ecological impact quantification associated with manufacturing at least a portion of a product according to product construction material identification data. For example, the product specification data received via the product specification module 401 may include raw materials used in the manufacture of product 102. The LCM 118/418 may query the product information repository 202 of database 114/414 to determine various ecological impact characteristics of the raw materials used in the manufacture of product 102. The LCM 118/418 may compare the amount of a given raw material to a threshold amount (e.g. as governmentally recommended amount) of the given raw materials maintained in threshold table 234. Should the amount of raw material be below the threshold allowable amount of the given raw material, it may be indicative of a reduced ecological impact associated with the manufacturing of the product 102. Should the amount of the given raw material be above the threshold amount, it may be indicative of an increased ecological impact associated with the manufacturing of the product 102. The LCM 118/418 may compute an ecological impact quantification according to the comparison between the amount of raw material and the threshold amount of raw materials. For example, an amount of the given raw material below the threshold amount may be mapped to a ecological impact quantification of “1”, an amount of the given raw material substantially equal to the threshold amount may be mapped to a ecological impact quantification of “2” and an amount of the given raw material above the threshold amount may be mapped to a ecological impact quantification of “3.”

Operation 604 shows computing an ecological impact quantification associated with manufacturing at least a portion of a product according to an amount of rare-earth materials in the product. For example, the product specification data received via the product specification module 401 may include raw materials used in the manufacture of product 102. The LCM 118/418 may query the rare-earth materials table 210 of database 114/414 to determine whether any of the raw materials used in the manufacture of product 102 are classified as rare-earth materials. The LCM 118/418 may compare the amount of raw material classified as rare-earth materials to a threshold amount of rare-earth materials maintained in threshold table 234. Should the amount of rare-earth material in product 102 be below a threshold allowable amount of the rare-earth material, it may be indicative of a reduced ecological impact associated with the manufacturing of the product 102. Should the amount of the rare-earth material in product 102 be above the threshold amount, it may be indicative of an increased ecological impact associated with the manufacturing of the product 102. The LCM 118/418 may compute an ecological impact quantification according to the comparison between the amount of rare-earth material and the threshold amount of rare-earth materials. For example, an amount rare-earth material below the threshold amount may be mapped to a ecological impact quantification of “1”, an amount rare-earth material substantially equal to the threshold amount may be mapped to a ecological impact quantification of “2” and an amount of rare-earth material above the threshold amount may be mapped to a ecological impact quantification of “3.”

Operation 606 shows computing an ecological impact quantification associated with manufacturing at least a portion of a product according to an amount of hazardous materials in the product. For example, the product specification data received via the product specification module 401 may include raw materials used in the manufacture of product 102. The LCM 118/418 may query the hazardous materials table 204 of database 114/414 to determine whether any of the raw materials used in the manufacture of product 102 are classified as hazardous materials. The LCM 118/418 may compare the amount of a raw material classified as hazardous materials to a threshold amount of hazardous materials maintained in threshold table 234. Should the amount of hazardous material in product 102 be below a threshold allowable amount of the hazardous material, it may be indicative of a reduced ecological impact associated with the manufacturing of the product 102. Should the amount of the hazardous material in product 102 be above the threshold amount, it may be indicative of an increased ecological impact associated with the manufacturing of the product 102. The LCM 118/418 may compute an ecological impact quantification according to the comparison between the amount of hazardous material and the threshold amount of hazardous materials. For example, an amount hazardous material below the threshold amount may be mapped to a ecological impact quantification of “1”, an amount hazardous material substantially equal to the threshold amount may be mapped to a ecological impact quantification of “2” and an amount of hazardous material above the threshold amount may be mapped to a ecological impact quantification of “3.”

Operation 608 shows computing an ecological impact quantification associated with manufacturing at least a portion of a product according to an amount of ground pollutants in the product. For example, the product specification data received via the product specification module 401 may include raw materials used in the manufacture of product 102. The LCM 118/418 may query the ground pollutant materials table 204 of database 114/414 to determine whether any of the raw materials used in the manufacture of product 102 are classified as ground pollutant materials. The LCM 118/418 may compare the amount of a raw material classified as ground pollutant materials to a threshold amount of ground pollutant materials maintained in threshold table 234. Should the amount of ground pollutant material in product 102 be below a threshold allowable amount of the ground pollutant material, it may be indicative of a reduced ecological impact associated with the manufacturing of the product 102. Should the amount of the ground pollutant material in product 102 be above the threshold amount, it may be indicative of an increased ecological impact associated with the manufacturing of the product 102. The LCM 118/418 may compute an ecological impact quantification according to the comparison between the amount of ground pollutant material and the threshold amount of ground pollutant materials. For example, an amount ground pollutant material below the threshold amount may be mapped to a ecological impact quantification of “1”, an amount ground pollutant material substantially equal to the threshold amount may be mapped to a ecological impact quantification of “2” and an amount of ground pollutant material above the threshold amount may be mapped to a ecological impact quantification of “3.”

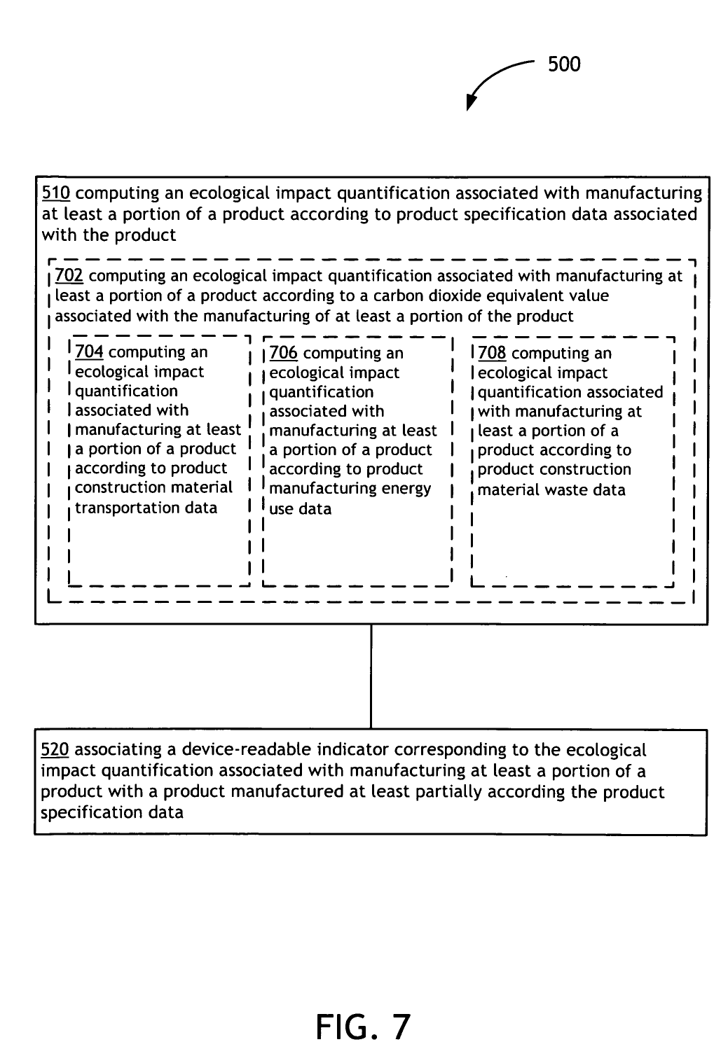

FIG. 7 illustrates an example embodiment where operation 502 of the example operational flow 500 of FIG. 5 may include at least one additional operation. Additional operations may include an operation 702, 704, 706 and/or 708.

Operation 702 shows computing an ecological impact quantification associated with manufacturing at least a portion of a product according to a carbon dioxide equivalent value associated with the manufacturing of at least a portion of the product. For example, the product specification data received via the product specification module 401 may include manufacturing process steps for manufacturing the product 102 and/or parameters associated with those manufacturing process steps. The LCM 118/418 may query the CO₂e table 206 of database 114/414 to determine the CO₂e value associated with a manufacturing process step for the product 102. Upon a determination of the CO₂e value associated with the manufacturing process step, LCM 118/418 may compare the CO₂e value to a threshold CO₂e value maintained in threshold table 234. Should the CO₂e value associated with the manufacturing process step be below the threshold CO₂e value, it may be indicative of a reduced ecological impact associated with the manufacturing of the product 102. Should the CO₂e value associated with the manufacturing process step be above the threshold CO₂e value, it may be indicative of an increased ecological impact associated with the manufacturing of the product 102. The LCM 118/418 may compute an ecological impact quantification according to a comparison between the CO₂e value associated with the manufacturing process step and the threshold CO₂e value. For example, a CO₂e value associated with the manufacturing process step below the threshold CO₂e value may be mapped to a ecological impact quantification of “1”, a CO₂e value associated with the manufacturing process step to the threshold CO₂e value may be mapped to an ecological impact quantification of “2” and a CO₂e value associated with the manufacturing process step above the threshold CO₂e value may be mapped to a ecological impact quantification of “3.”

Operation 704 shows computing an ecological impact quantification associated with manufacturing at least a portion of a product according to product construction material transportation data. For example, the product specification data received via the product specification module 401 may include product construction material transportation data (e.g. material transportation mileage, material transportation method (e.g. rail, truck, ship, aircraft, etc.) associated with manufacturing the product 102. The LCM 118/418 may query the CO₂e table 206 of database 114/414 to determine the CO₂e value associated with the product construction material transportation data. Upon a determination of the CO₂e value associated with the product construction material transportation data, LCM 118/418 may compare the CO₂e value to a threshold CO₂e value maintained in threshold table 234. Should the CO₂e value associated with the product construction material transportation data be below the threshold CO₂e value, it may be indicative of a reduced ecological impact associated with the manufacturing of the product 102. Should the CO₂e value associated with the product construction material transportation data be above the threshold CO₂e value, it may be indicative of an increased ecological impact associated with the manufacturing of the product 102. The LCM 118/418 may compute an ecological impact quantification according to a comparison between the CO₂e value associated with the product construction material transportation data and the threshold CO₂e value. For example, a CO₂e value associated with the product construction material transportation data below the threshold CO₂e value may be mapped to a ecological impact quantification of “1”, a CO₂e value associated with the product construction material transportation data to the threshold CO₂e value may be mapped to an ecological impact quantification of “2” and a CO₂e value associated with the product construction material transportation data above the threshold CO₂e value may be mapped to a ecological impact quantification of “3.”

Operation 706 shows computing an ecological impact quantification associated with manufacturing at least a portion of a product according to product manufacturing energy use data. For example, the product specification data received via the product specification module 401 may include product manufacturing energy use data (e.g. process step parameters (e.g. process step durations, temperatures, pressures) energy consumption rates for a process step, energy sources supplying the energy, etc.) associated with manufacturing the product 102. The LCM 118/418 may query the CO₂e table 206 of database 114/414 to determine the CO₂e value associated with the product manufacturing energy use data. Upon a determination of the CO₂e value associated with the product manufacturing energy use data, LCM 118/418 may compare the CO₂e value to a threshold CO₂e value maintained in threshold table 234. Should the CO₂e value associated with the product manufacturing energy use data be below the threshold CO₂e value, it may be indicative of a reduced ecological impact associated with the manufacturing of the product 102. Should the CO₂e value associated with the product manufacturing energy use data be above the threshold CO₂e value, it may be indicative of an increased ecological impact associated with the manufacturing of the product 102. The LCM 118/418 may compute an ecological impact quantification according to a comparison between the CO₂e value associated with the product manufacturing energy use data and the threshold CO₂e value. For example, a CO₂e value associated with the product manufacturing energy use data below the threshold CO₂e value may be mapped to a ecological impact quantification of “1”, a CO₂e value associated with the product manufacturing energy use data to the threshold CO₂e value may be mapped to an ecological impact quantification of “2” and a CO₂e value associated with the product manufacturing energy use data above the threshold CO₂e value may be mapped to a ecological impact quantification of “3.”

Operation 708 shows computing an ecological impact quantification associated with manufacturing at least a portion of a product according to product construction material waste data. For example, the product specification data received via the product specification module 401 may include product construction material waste data (e.g. product raw material acquisition amounts, product raw material manufacturing usage amounts, raw materials waste amounts, waste disposal methodologies (e.g. recycling, landfill, incineration, etc.) associated with manufacturing the product 102. The LCM 118/418 may query the CO₂e table 206 of database 114/414 to determine the CO₂e value associated with the product construction material waste data. Upon a determination of the CO₂e value associated with the product construction material waste data, LCM 118/418 may compare the CO₂e value to a threshold CO₂e value maintained in threshold table 234. Should the CO₂e value associated with the product construction material waste data be below the threshold CO₂e value, it may be indicative of a reduced ecological impact associated with the manufacturing of the product 102. Should the CO₂e value associated with the product construction material waste data be above the threshold CO₂e value, it may be indicative of an increased ecological impact associated with the manufacturing of the product 102. The LCM 118/418 may compute an ecological impact quantification according to a comparison between the CO₂e value associated with the product construction material waste data and the threshold CO₂e value. For example, a CO₂e value associated with the product construction material waste data below the threshold CO₂e value may be mapped to a ecological impact quantification of “1”, a CO₂e value associated with the product construction material waste data to the threshold CO₂e value may be mapped to an ecological impact quantification of “2” and a CO₂e value associated with the product construction material waste data above the threshold CO₂e value may be mapped to a ecological impact quantification of “3.”

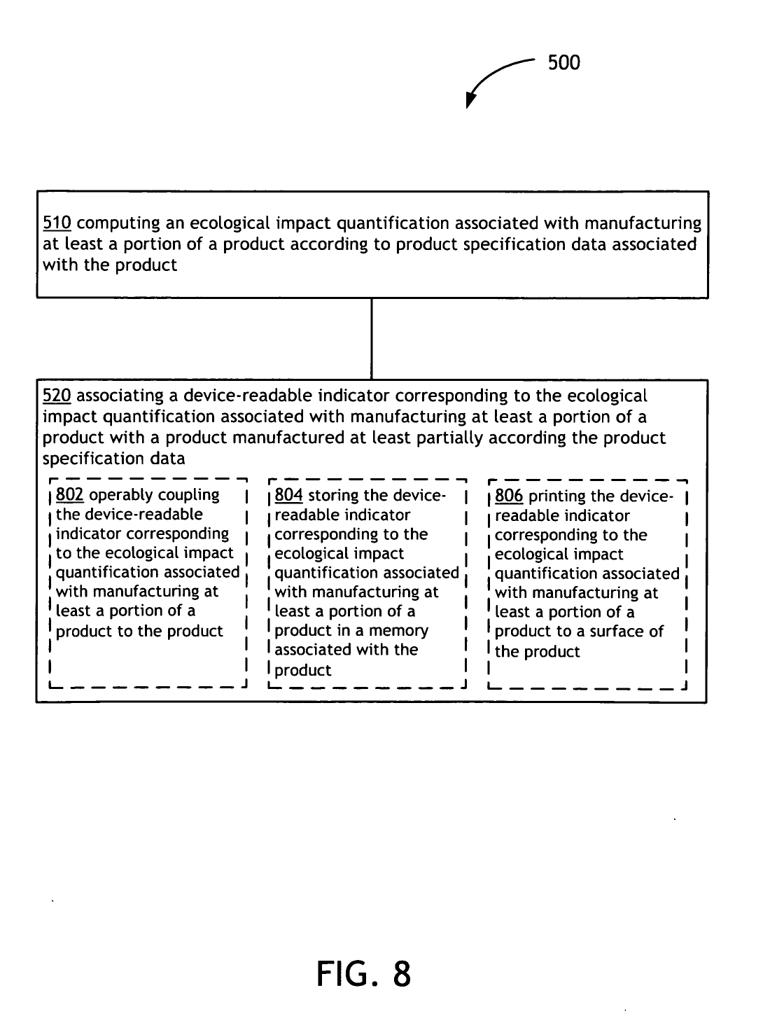

FIG. 8 illustrates an example embodiment where operation 504 of the example operational flow 500 of FIG. 5 may include at least one additional operation. Additional operations may include an operation 802, 804 and/or 806.

Operation 802 shows operably coupling a device including the device-readable indicator corresponding to the ecological impact quantification associated with manufacturing at least a portion of a product to the product. For example, following a computation of the ecological impact quantification associated with manufacturing at least a portion of a product 102 according to product specification data (e.g. construction materials, materials transportation data, energy use associated with product manufacturing, etc.) received via the product specification module 401, the ecological impact quantification may be associated with (e.g. stored in) a device (e.g. an RFID chip) including the device-readable indicator 314. The device-readable indicator 314 corresponding to the ecological impact quantification can then be associated with the product 102 by operably coupling (e.g. electrically connecting, wirelessly connecting, adhering, bolting, enclosing within, etc.) the device including the device-readable indicator 314 to the product 102.

Operation 804 shows storing the device-readable indicator corresponding to the ecological impact quantification associated with manufacturing at least a portion of a product in a memory associated with the product. For example, following a computation of the ecological impact quantification associated with manufacturing at least a portion of a product 102 according to product specification data (e.g. construction materials, materials transportation data, energy use associated with product manufacturing, etc.) received via the product specification module 401, the ecological impact quantification may be associated with (e.g. encoded as) a device-readable indicator 314. The device-readable indicator 314 can then be associated with the product 102 by storing the device-readable indicator corresponding to the ecological impact quantification in a memory associated with (e.g. electrically coupled to, physically coupled to, etc.) the product 102.

Operation 806 shows printing the device-readable indicator corresponding to the ecological impact quantification associated with manufacturing at least a portion of a product to a surface of the product. For example, following a computation of the ecological impact quantification associated with manufacturing at least a portion of a product 102 according to product specification data (e.g. construction materials, materials transportation data, energy use associated with product manufacturing, etc.) received via the product specification module 401, the ecological impact quantification may be associated with (e.g. encoded as) a device-readable indicator 314 (e.g. a barcode). The device-readable indicator 314 can then be associated with the product 102 by printing the device-readable indicator corresponding to the ecological impact quantification on a surface of the product 102.

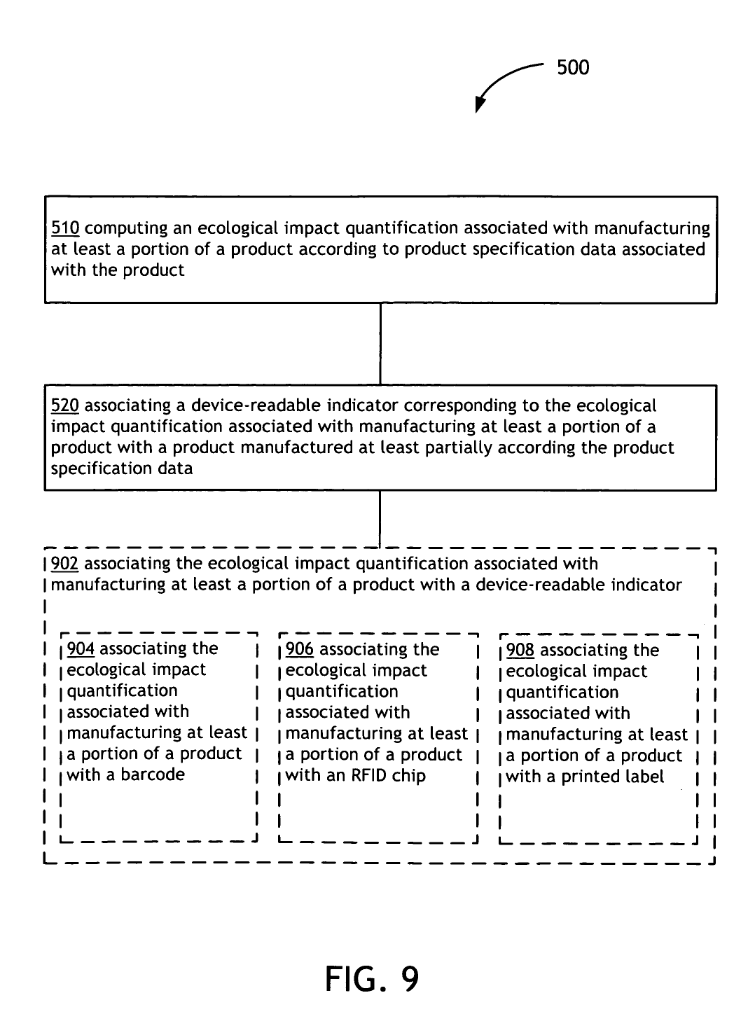

FIG. 9 illustrates an example embodiment where example operational flow 500 of FIG. 5 may include at least one additional operation. Additional operations may include an operation 902, 904, 906 and/or 908.

Operation 902 shows associating the ecological impact quantification associated with manufacturing at least a portion of a product with a device-readable indicator. For example, following a computation of the ecological impact quantification associated with manufacturing at least a portion of a product 102 according to product specification data (e.g. construction materials, materials transportation data, energy use associated with product manufacturing, etc.) received via the product specification module 401, the ecological impact quantification may be associated with (e.g. encoded as, mapped to, stored in device including) the device-readable indicator 314.

Operation 904 shows associating the ecological impact quantification associated with manufacturing at least a portion of a product with a barcode. For example, following a computation of the ecological impact quantification associated with manufacturing at least a portion of a product 102 according to product specification data (e.g. construction materials, materials transportation data, energy use associated with product manufacturing, etc.) received via the product specification module 401, the ecological impact quantification may be encoded as barcode-type device-readable indicator 314 that may be printed to a surface of the product 102.

Operation 906 shows associating the ecological impact quantification associated with manufacturing at least a portion of a product with an RFID chip. For example, following a computation of the ecological impact quantification associated with manufacturing at least a portion of a product 102 according to product specification data (e.g. construction materials, materials transportation data, energy use associated with product manufacturing, etc.) received via the product specification module 401, the ecological impact quantification may be stored in an RFID-type device-readable indicator 314 that may be operably coupled to the product 102.

Operation 908 shows associating the ecological impact quantification associated with manufacturing at least a portion of a product with a printed label. For example, following a computation of the ecological impact quantification associated with manufacturing at least a portion of a product 102 according to product specification data (e.g. construction materials, materials transportation data, energy use associated with product manufacturing, etc.) received via the product specification module 401, the ecological impact quantification may be printed on a label-type device-readable indicator 314 which may be adhered to the product 102.

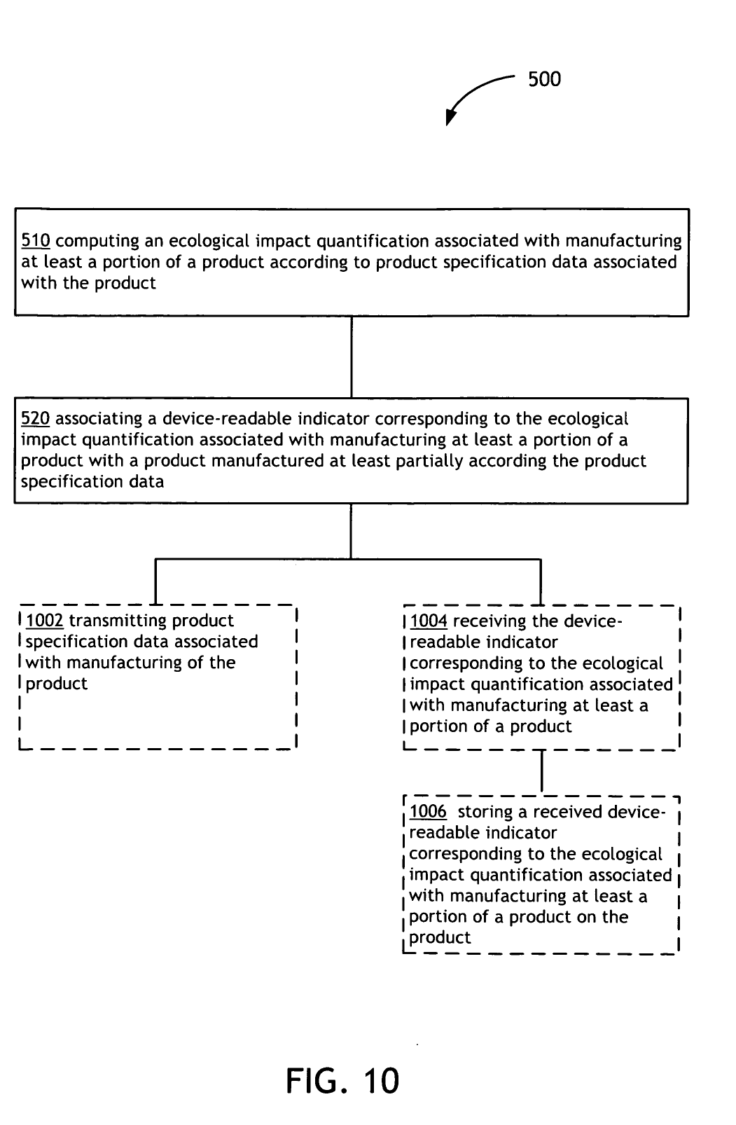

FIG. 10 illustrates an example embodiment where example operational flow 500 of FIG. 5 may include at least one additional operation. Additional operations may include an operation 1002, 1004, 1006 and/or 1008.

Operation 1002 shows transmitting product specification data associated with manufacturing of the product. For example as shown in FIGS. 1-4, the product specification module 401 may receive product specification data (e.g. user inputs from designers, process engineers, business executives) defining one or more manufacturing characteristics associated with a product 102 (e.g. construction materials, materials transportation data, energy use associated with product manufacturing). The product specification module 401 then may then transmit the product specification data to a remotely located system 106 associated with ecological service provider 112. For example, the network adapter 414 of product specification module 401 may transmit the product specification data to the network adapter 114 of 106 associated with ecological service provider 112 via network 100.

Operation 1004 shows receiving the device-readable indicator corresponding to the ecological impact quantification associated with manufacturing at least a portion of a product. Following receipt of the product specification data by the system 106 associated with ecological service provider 112, the LCM 118 of system 106 may correlate that product specification data to product information repository data maintained in product information repository 202 of database 114. The LCM 118 may compute an ecological impact quantification associated with the product specification data for the product from the product information repository data maintained in database as described above with respect to operation 502. Following computation of the ecological impact quantification, the ecological impact quantification may be associated with (e.g. encoded as, mapped to) a device-readable indicator 314. This device-readable indicator may then be transmitted to and received by the product 102 and/or the product specification module 401 The device-readable indicator may be associated (e.g. stored in memory associated with the product 102, affixed as a barcode or other optically readable format, stored in an RFID) with the product 102.

Operation 1004 shows storing a received device-readable indicator corresponding to the ecological impact quantification associated with manufacturing at least a portion of a product on the product. Following receipt of the device-readable indicator 314 corresponding to an ecological impact quantification associated with manufacturing at least a portion of a product on the product 102, the device-readable indicator 314 may be stored to a memory or RFID chip which may be read by device 302 to access the device-readable indicator 314.

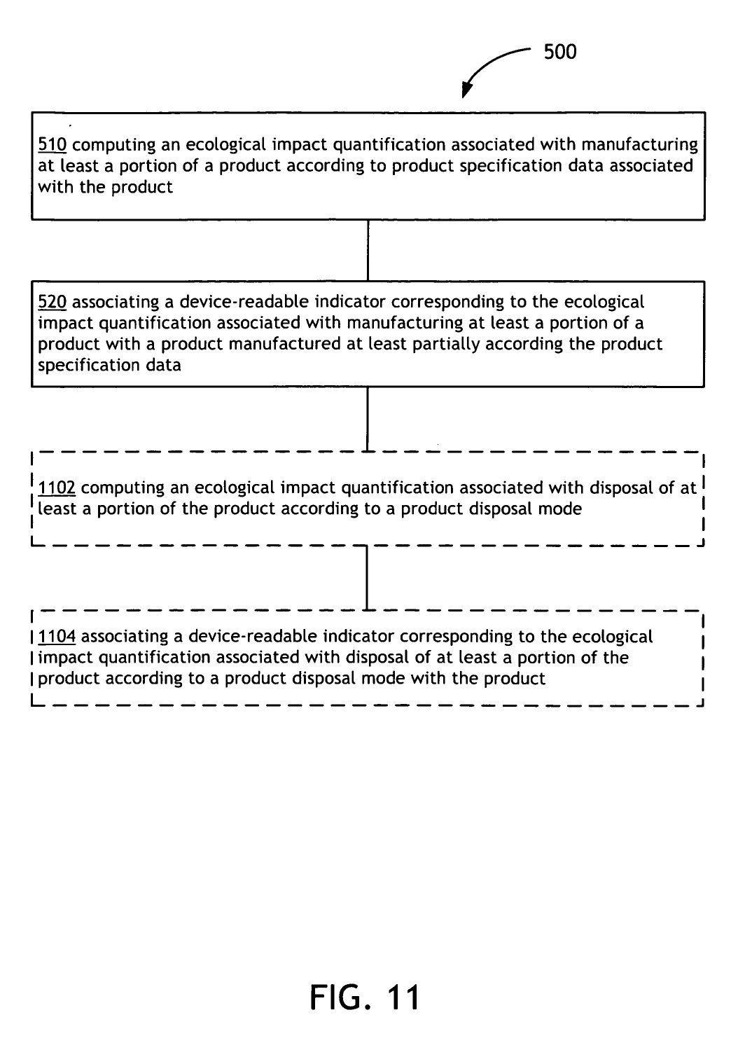

FIG. 11 illustrates an example embodiment where example operational flow 500 of FIG. 5 may include at least one additional operation. Additional operations may include an operation 1102, 1104, 1106 and/or 1108.

Operation 1102 shows computing an ecological impact quantification associated with disposal of at least a portion of the product according to a product disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to a product disposal mode from the product information repository data maintained in database 114/414.

The product specification data may include raw materials used in the manufacture of product 102. The LCM 118/418 may query the disposal phase quantification table 220 of database 114/414 to determine the various disposal mode options for disposing of the product based on the raw materials used in the manufacture of product 102 and assign an ecological impact quantification to one or more disposal modes according to the raw materials used in the manufacture of product 102.

For example, if a product 102 contains a high percentage of recyclable materials, the LCM 118/418 may compute a relatively low ecological impact quantification for a disposal of the product 102 according to a recycling disposal mode. Alternatively, if a product 102 contains a low percentage of recyclable materials, the LCM 118/418 may compute a relatively high ecological impact quantification for a disposal of the product 102 according to a recycling disposal mode.

As a further example, if a product 102 contains a high percentage of hazardous materials, the LCM 118/418 may compute a relatively high ecological impact quantification for a disposal of the product 102 according to a landfill disposal mode. Alternatively, if a product 102 contains a high percentage of hazardous materials, the LCM 118/418 may compute a relatively low ecological impact quantification for a disposal of the product 102 according to an incineration disposal mode.

Operation 1104 shows associating a device-readable indicator corresponding to the ecological impact quantification associated with disposal of at least a portion of the product according to a product disposal mode with the product. Following the computation of the ecological impact quantification with disposal of the product 102 according to various disposal mode parameters stored, the ecological impact quantification may be associated with (e.g. encoded as, stored in, mapped to) a device-readable indicator 314 associated with the product 102. For example, the ecological impact quantification could be mapped to device-readable indicator 314 (e.g. a numerical value) stored in an RFID-type device affixed to the product 102. Device 302 can obtain device-readable indicator 314 by communicating with product 102 and/or extracting it from product 102.

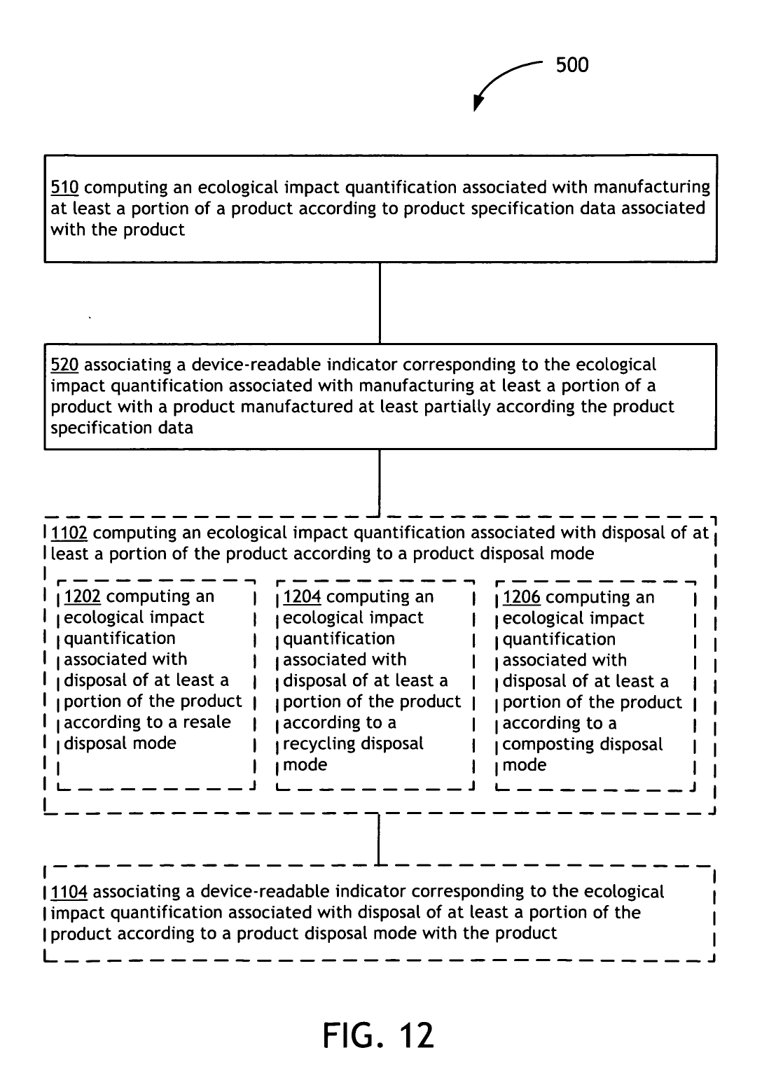

FIG. 12 illustrates an example embodiment where the operation 1102 of example operational flow 500 of FIG. 11 may include at least one additional operation. Additional operations may include an operation 1202, 1204 and/or 1206.

Operation 1202 shows computing an ecological impact quantification associated with disposal of at least a portion of the product according to a resale disposal mode. For example as shown in FIGS. 1-4, the product specification module 401 may receive product specification data (e.g. user inputs from designers, process engineers, business executives) defining one or more characteristics associated with a product 102 (e.g. a product lifespan). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to a resale disposal mode from the product information repository data maintained in database 114/414.

For example, the product 102 (e.g. a battery) may have energy usage properties (e.g. storage capacity) that degrade over its lifespan. In this case, the LCM 118/418 may compute a time-dependent ecological impact quantification for a disposal of the product 102 according to a resale disposal mode. Specifically, if the LCM 118/418 determines that the product is relatively close to the beginning of its product lifespan (e.g. by comparing a product manufacturing date to a current date), the LCM 118/418 may compute a relatively low ecological impact quantification for a disposal of the product 102 according to a resale disposal mode. Alternatively, if a product 102 is nearing the end of its product lifespan, the LCM 118/418 may compute a relatively high ecological impact quantification (e.g. the ecological impact costs of carrying out the resale transaction (e.g. shipping the product) outweigh the useful portion of the product lifespan) for a disposal of the product 102 according to a resale disposal mode.

Operation 1204 shows computing an ecological impact quantification associated with disposal of at least a portion of the product according to a recycling disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to a product recycling disposal mode from the product information repository data maintained in database 114/414.

For example, if a product 102 contains a high percentage of recyclable materials, the LCM 118/418 may compute a relatively low ecological impact quantification for a disposal of the product 102 according to a recycling disposal mode. Alternatively, if a product 102 contains a low percentage of recyclable materials, the LCM 118/418 may compute a relatively high ecological impact quantification for a disposal of the product 102 according to a recycling disposal mode.

Operation 1206 shows computing an ecological impact quantification associated with disposal of at least a portion of the product according to a composting disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to a composting disposal mode from the product information repository data maintained in database 114/414.

For example, if a product 102 contains a high percentage of materials that, upon degradation, provide one or more reusable byproduct materials, the LCM 118/418 may compute a relatively low ecological impact quantification for a disposal of the product 102 according to a composting disposal mode. Alternatively, if a product 102 contains a low percentage of materials that, upon degradation, provide one or more reusable byproduct materials, the LCM 118/418 may compute a relatively high ecological impact quantification for a disposal of the product 102 according to a composting disposal mode.

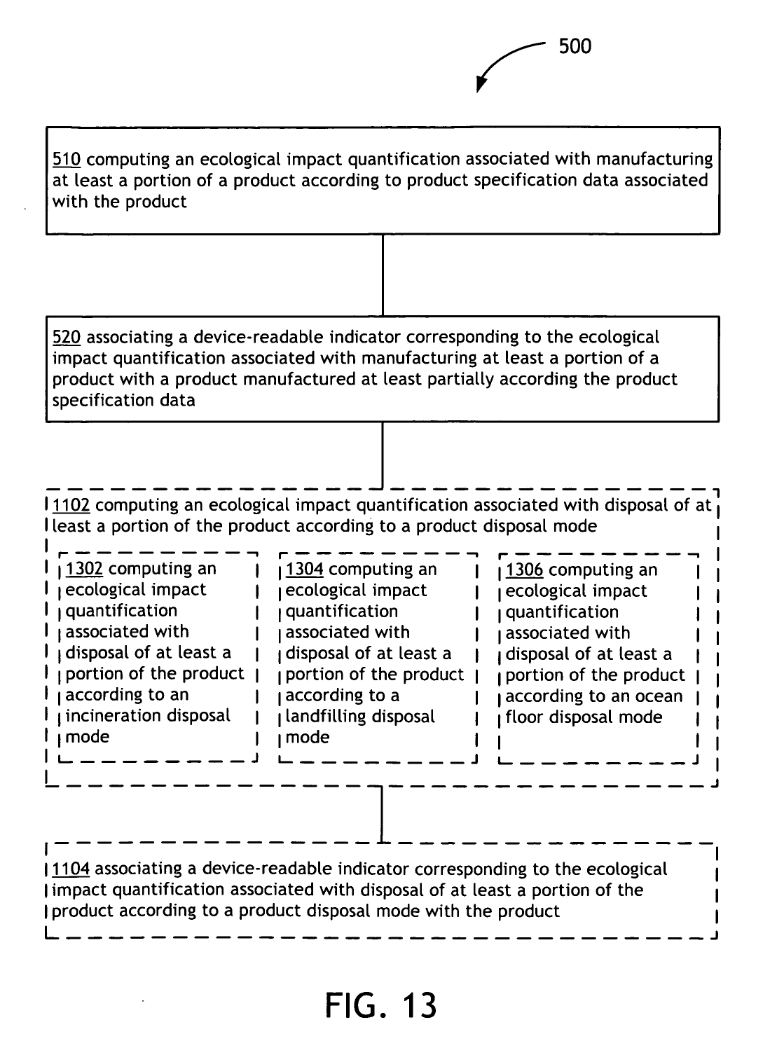

FIG. 13 illustrates an example embodiment where the operation 1102 of example operational flow 500 of FIG. 11 may include at least one additional operation. Additional operations may include an operation 1302, 1304 and/or 1306.

Operation 1302 shows computing an ecological impact quantification associated with disposal of at least a portion of the product according to an incineration disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to an incineration disposal mode from the product information repository data maintained in database 114/414.

For example, if a product 102 contains a high percentage of materials that, upon exposure to excessive heat, generate one or more hazardous byproducts or are highly explosive, the LCM 118/418 may compute a relatively high ecological impact quantification for a disposal of the product 102 according to an incineration disposal mode. Alternatively, if a product 102 contains a low percentage of materials that, upon degradation, upon exposure to excessive heat, generate one or more hazardous byproducts or are highly explosive, the LCM 118/418 may compute a relatively low ecological impact quantification for a disposal of the product 102 according to a composting disposal mode.

Operation 1304 shows computing an ecological impact quantification associated with disposal of at least a portion of the product according to a landfilling disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to a landfilling disposal mode from the product information repository data maintained in database 114/414.

For example, if a product 102 contains a high percentage of biodegradable materials, the LCM 118/418 may compute a relatively low ecological impact quantification for a disposal of the product 102 according to an incineration disposal mode. Alternatively, if a product 102 contains a low percentage of biodegradable materials, the LCM 118/418 may compute a relatively high ecological impact quantification for a disposal of the product 102 according to a composting disposal mode.

Operation 1306 shows computing an ecological impact quantification associated with disposal of at least a portion of the product according to an ocean floor disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to an ocean floor disposal mode from the product information repository data maintained in database 114/414.

For example, if a product 102 contains a high percentage of water-soluble materials, the LCM 118/418 may compute a relatively low ecological impact quantification for a disposal of the product 102 according to an incineration disposal mode. Alternatively, if a product 102 contains a low percentage of water-soluble materials, the LCM 118/418 may compute a relatively high ecological impact quantification for a disposal of the product 102 according to a composting disposal mode.

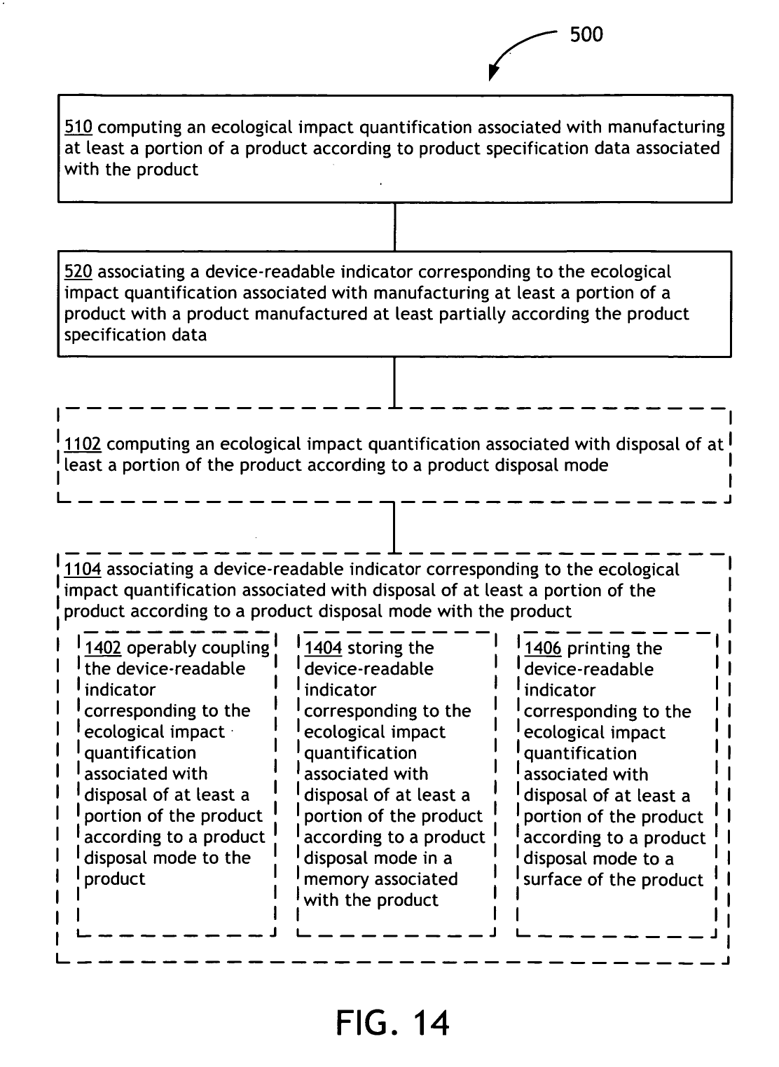

FIG. 14 illustrates an example embodiment where the operation 1104 of example operational flow 500 of FIG. 11 may include at least one additional operation. Additional operations may include an operation 1402, 1404 and/or 1406.

Operation 1402 shows operably coupling the device-readable indicator corresponding to the ecological impact quantification associated with disposal of at least a portion of the product according to a product disposal mode to the product. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be associated with (e.g. stored in) a device (e.g. an RFID chip) as a device-readable indicator 314. The device-readable indicator 314 corresponding to the ecological impact quantification can then be associated with the product 102 by operably coupling (e.g. electrically connecting, wirelessly connecting, adhering, bolting, enclosing within, etc.) the device including the device-readable indicator 314 to the product 102.

Operation 1404 shows storing the device-readable indicator corresponding to the ecological impact quantification associated with disposal of at least a portion of the product according to a product disposal mode in a memory associated with the product. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be associated with (e.g. encoded as) a device-readable indicator 314. The device-readable indicator 314 can then be associated with the product 102 by storing the device-readable indicator corresponding to the ecological impact quantification in a memory associated with (e.g. electrically coupled to, physically coupled to, etc.) the product 102.

Operation 1406 shows printing the device-readable indicator corresponding to the ecological impact quantification associated with disposal of at least a portion of the product according to a product disposal mode to a surface of the product. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be associated with (e.g. encoded as) a device-readable indicator 314 (e.g. a barcode). The device-readable indicator 314 can then be associated with the product 102 by printing the device-readable indicator corresponding to the ecological impact quantification on a surface of the product 102.

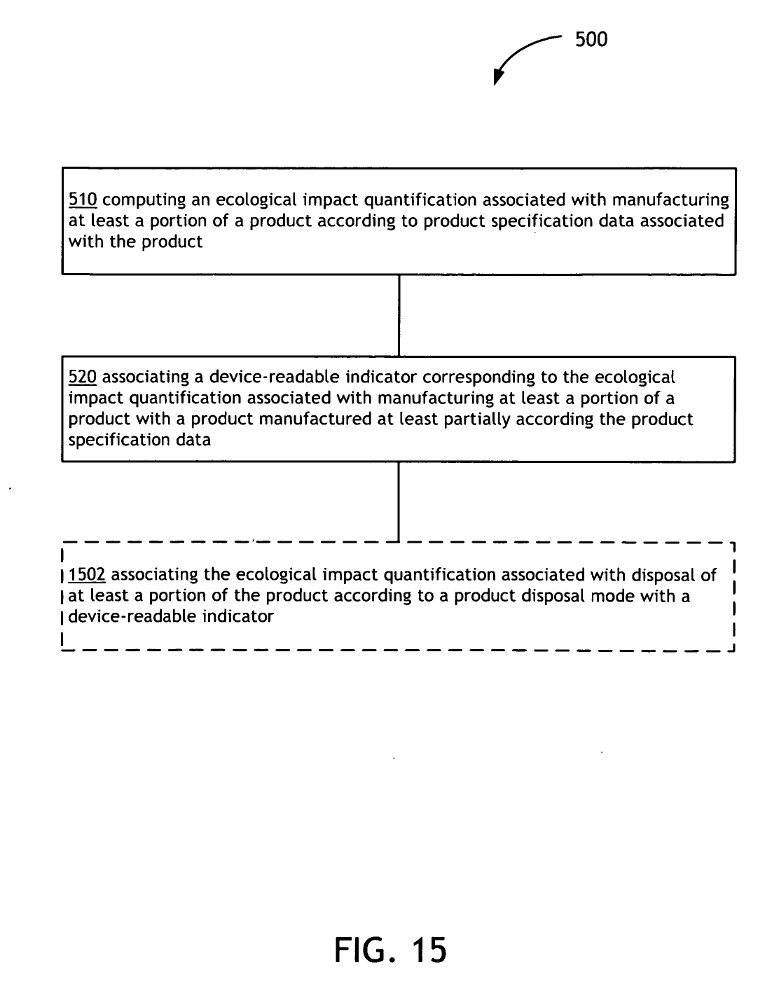

FIG. 15 illustrates an example embodiment where the example operational flow 500 of FIG. 11 may include at least one additional operation. Additional operations may include an operation 1502.

Operation 1502 shows associating the ecological impact quantification associated with disposal of at least a portion of the product according to a product disposal mode with a device-readable indicator. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be associated with (e.g. encoded as, mapped to, stored in device including) the device-readable indicator 314.

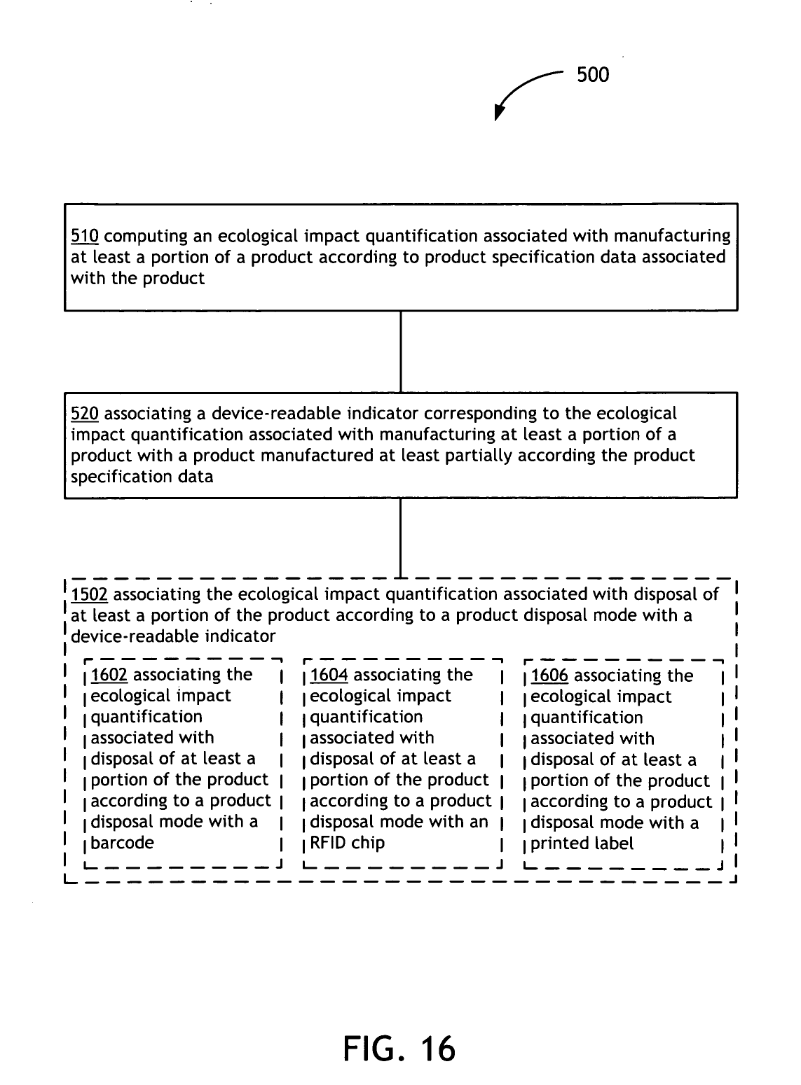

FIG. 16 illustrates an example embodiment where the operation 1502 of example operational flow 500 of FIG. 15 may include at least one additional operation. Additional operations may include an operation 1602, 1604 and/or 1606.

Operation 1602 shows associating the ecological impact quantification associated with disposal of at least a portion of the product according to a product disposal mode with a barcode. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be encoded as barcode-type device-readable indicator 314 that may be printed to a surface of the product 102.

Operation 1604 shows associating the ecological impact quantification associated with disposal of at least a portion of the product according to a product disposal mode with an RFID chip. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be stored in an RFID-type device-readable indicator 314 that may be operably coupled to the product 102.

Operation 1606 shows associating the ecological impact quantification associated with disposal of at least a portion of the product according to a product disposal mode with a printed label. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be printed on a label-type device-readable indicator 314 which may be adhered to the product 102.

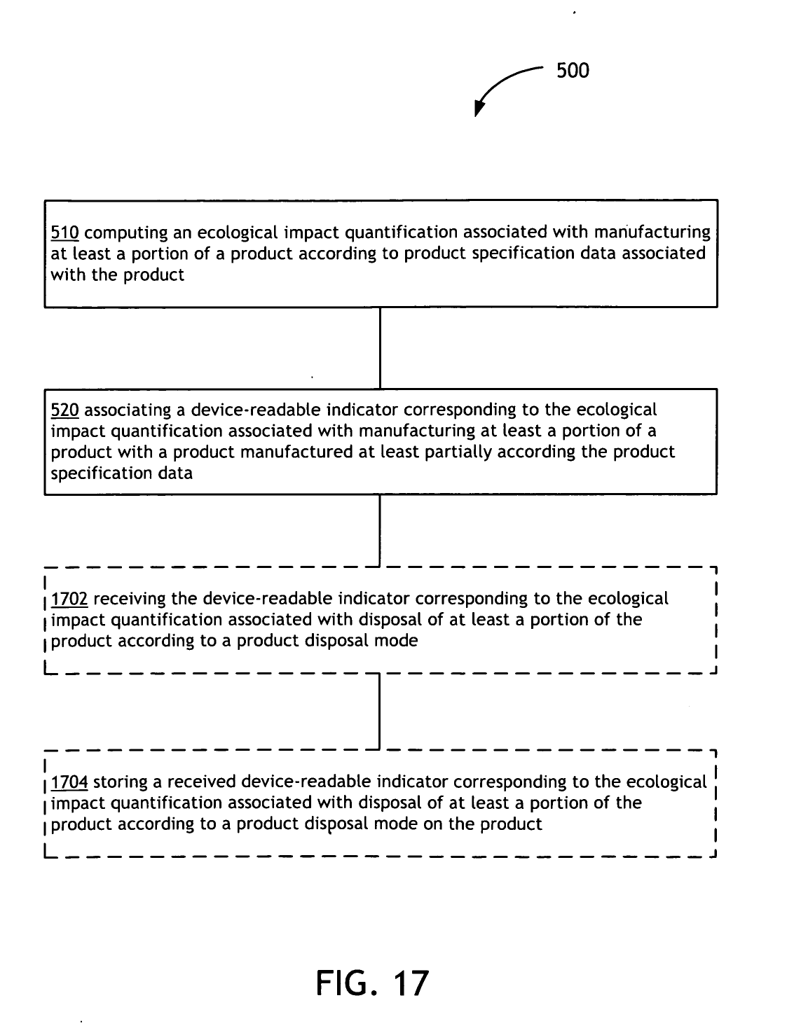

FIG. 17 illustrates an example embodiment where the example operational flow 500 of FIG. 5 may include at least one additional operation. Additional operations may include an operation 1702 and/or 1704.

Operation 1702 shows receiving the device-readable indicator corresponding to the ecological impact quantification associated with disposal of at least a portion of the product according to a product disposal mode. For example, following receipt of product specification data and product disposal data by the system 106 associated with ecological service provider 112, the LCM 118 of system 106 may correlate that product specification data and product disposal data to disposal mode identifier table 214 and/or disposal phase quantification table 220 of database 114. The LCM 118 may compute an ecological impact quantification associated with the product specification data and product disposal data for the product from the disposal mode identifier table 214 and/or disposal phase quantification table 220 as described above with respect to operation 502. Following computation of the ecological impact quantification associated with disposal of at least a portion of the product 102, the ecological impact quantification may be associated with (e.g. encoded as, mapped to) a device-readable indicator 314. This device-readable indicator may then be transmitted to and received by the product 102 and/or the product specification module 401 The device-readable indicator may then be associated (e.g. stored in memory associated with the product 102, affixed as a barcode or other optically readable format, stored in an RFID) with the product 102.

Operation 1704 shows storing a received device-readable indicator corresponding to the ecological impact quantification associated with disposal of at least a portion of the product according to a product disposal mode on the product. Following receipt of the device-readable indicator 314 corresponding to an ecological impact quantification associated with disposal of at least a portion of the product 102, the device-readable indicator 314 may be stored to a memory or RFID chip on the product 102 which may be read by device 302 to access the device-readable indicator 314.

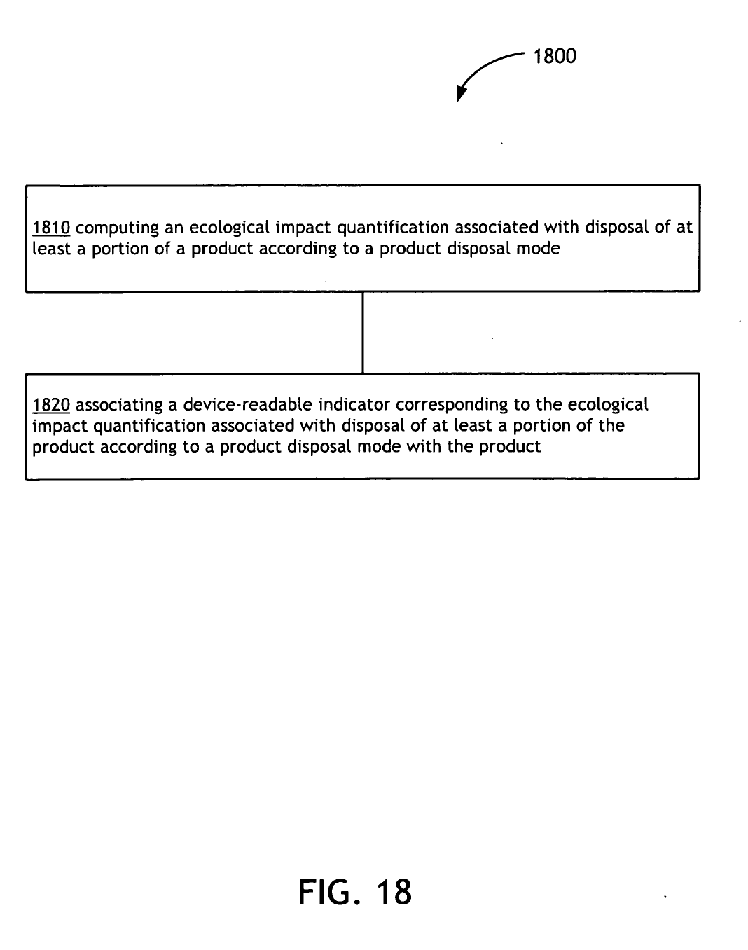

FIG. 18 illustrates an operational procedure 1800 including operations 1802 and 1804.

Operation 1802 shows computing an ecological impact quantification associated with disposal of at least a portion of the product according to a product disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to a product disposal mode from the product information repository data maintained in database 114/414.

The product specification data may include raw materials used in the manufacture of product 102. The LCM 118/418 may query the disposal phase quantification table 220 of database 114/414 to determine the various disposal mode options for disposing of the product based on the raw materials used in the manufacture of product 102 and assign an ecological impact quantification to one or more disposal modes according to the raw materials used in the manufacture of product 102.

For example, if a product 102 contains a high percentage of recyclable materials, the LCM 118/418 may compute a relatively low ecological impact quantification for a disposal of the product 102 according to a recycling disposal mode. Alternatively, if a product 102 contains a low percentage of recyclable materials, the LCM 118/418 may compute a relatively high ecological impact quantification for a disposal of the product 102 according to a recycling disposal mode.

As a further example, if a product 102 contains a high percentage of hazardous materials, the LCM 118/418 may compute a relatively high ecological impact quantification for a disposal of the product 102 according to a landfill disposal mode. Alternatively, if a product 102 contains a high percentage of hazardous materials, the LCM 118/418 may compute a relatively low ecological impact quantification for a disposal of the product 102 according to an incineration disposal mode.

Operation 1804 shows associating a device-readable indicator corresponding to the ecological impact quantification associated with disposal of at least a portion of the product according to a product disposal mode with the product. Following the computation of the ecological impact quantification with disposal of the product 102 according to various disposal mode parameters stored, the ecological impact quantification may be associated with (e.g. encoded as, stored in, mapped to) a device-readable indicator 314 associated with the product 102. For example, the ecological impact quantification could be mapped to device-readable indicator 314 (e.g. a numerical value) stored in an RFID-type device affixed to the product 102. Device 302 can obtain device-readable indicator 314 by communicating with product 102 and/or extracting it from product 102.

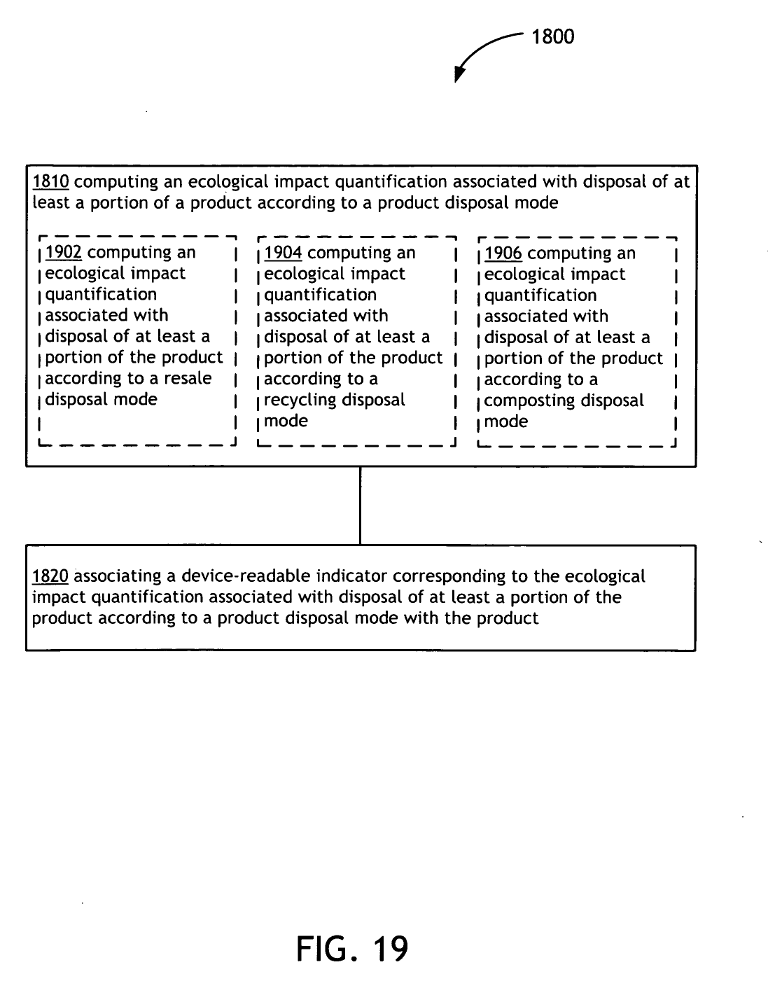

FIG. 19 illustrates an example embodiment where the operation 1802 of example operational flow 1800 of FIG. 18 may include at least one additional operation. Additional operations may include an operation 1902, 1904 and/or 1906.

Operation 1902 shows computing an ecological impact quantification associated with disposal of at least a portion of the product according to a resale disposal mode. For example as shown in FIGS. 1-4, the product specification module 401 may receive product specification data (e.g. user inputs from designers; process engineers, business executives) defining one or more characteristics associated with a product 102 (e.g. a product lifespan). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to a resale disposal mode from the product information repository data maintained in database 114/414.

For example, the product 102 (e.g. a battery) may have energy usage properties (e.g. storage capacity) that degrade over its lifespan. In this case, the LCM 118/418 may compute a time-dependent ecological impact quantification for a disposal of the product 102 according to a resale disposal mode. Specifically, if the LCM 118/418 determines that the product is relatively close to the beginning of its product lifespan (e.g. by comparing a product manufacturing date to a current date), the LCM 118/418 may compute a relatively low ecological impact quantification for a disposal of the product 102 according to a resale disposal mode. Alternatively, if a product 102 is nearing the end of its product lifespan, the LCM 118/418 may compute a relatively high ecological impact quantification (e.g. the ecological impact costs of carrying out the resale transaction (e.g. shipping the product) outweigh the useful portion of the product lifespan) for a disposal of the product 102 according to a resale disposal mode.

Operation 1904 shows computing an ecological impact quantification associated with disposal of at least a portion of the product according to a recycling disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to a product recycling disposal mode from the product information repository data maintained in database 114/414.

For example, if a product 102 contains a high percentage of recyclable materials, the LCM 118/418 may compute a relatively low ecological impact quantification for a disposal of the product 102 according to a recycling disposal mode. Alternatively, if a product 102 contains a low percentage of recyclable materials, the LCM 118/418 may compute a relatively high ecological impact quantification for a disposal of the product 102 according to a recycling disposal mode.

Operation 1906 shows computing an ecological impact quantification associated with disposal of at least a portion of the product according to a composting disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to a composting disposal mode from the product information repository data maintained in database 114/414.

For example, if a product 102 contains a high percentage of materials that, upon degradation, provide one or more reusable byproduct materials, the LCM 118/418 may compute a relatively low ecological impact quantification for a disposal of the product 102 according to a composting disposal mode. Alternatively, if a product 102 contains a low percentage of materials that, upon degradation, provide one or more reusable byproduct materials, the LCM 118/418 may compute a relatively high ecological impact quantification for a disposal of the product 102 according to a composting disposal mode.

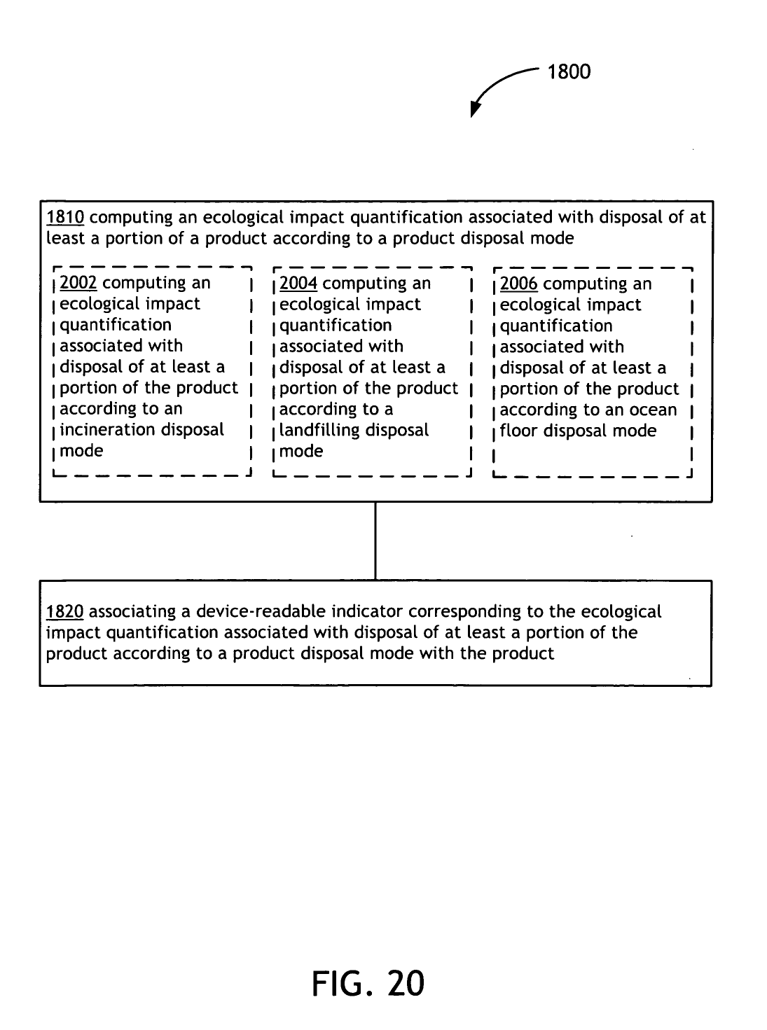

FIG. 20 illustrates an example embodiment where the operation 1802 of example operational flow 1800 of FIG. 18 may include at least one additional operation. Additional operations may include an operation 2002, 2004 and/or 2006.

Operation 2002 shows computing an ecological impact quantification associated with disposal of at least a portion of the product according to an incineration disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to an incineration disposal mode from the product information repository data maintained in database 114/414.

For example, if a product 102 contains a high percentage of materials that, upon exposure to excessive heat, generate one or more hazardous byproducts or are highly explosive, the LCM 118/418 may compute a relatively high ecological impact quantification for a disposal of the product 102 according to an incineration disposal mode. Alternatively, if a product 102 contains a low percentage of materials that, upon degradation, upon exposure to excessive heat, generate one or more hazardous byproducts or are highly explosive, the LCM 118/418 may compute a relatively low ecological impact quantification for a disposal of the product 102 according to a composting disposal mode.

Operation 2004 shows computing an ecological impact quantification associated with disposal of at least a portion of the product according to a landfilling disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to a landfilling disposal mode from the product information repository data maintained in database 114/414.

For example, if a product 102 contains a high percentage of biodegradable materials, the LCM 118/418 may compute a relatively low ecological impact quantification for a disposal of the product 102 according to an incineration disposal mode. Alternatively, if a product 102 contains a low percentage of biodegradable materials, the LCM 118/418 may compute a relatively high ecological impact quantification for a disposal of the product 102 according to a composting disposal mode.

Operation 2006 shows computing an ecological impact quantification associated with disposal of at least a portion of the product according to an ocean floor disposal mode. For example as shown in FIGS. 1-4, the product specification module 401 may receive product specification data (e.g. user inputs from designers, process engineers, business executives) defining one or more manufacturing characteristics associated with a product 102 (e.g. construction materials). The product specification module 401 may provide the product specification data to an LCM 118/418. The LCM 118/418 may receive product specification data associated with manufacturing the product 102 and correlate that product specification data to product information repository data maintained in product information repository 202 of database 114/414. The LCM may compute an ecological impact quantification associated with disposal of at least a portion of the product according to an ocean floor disposal mode from the product information repository data maintained in database 114/414.

For example, if a product 102 contains a high percentage of water-soluble materials, the LCM 118/418 may compute a relatively low ecological impact quantification for a disposal of the product 102 according to an incineration disposal mode. Alternatively, if a product 102 contains a low percentage of water-soluble materials, the LCM 118/418 may compute a relatively high ecological impact quantification for a disposal of the product 102 according to a composting disposal mode.

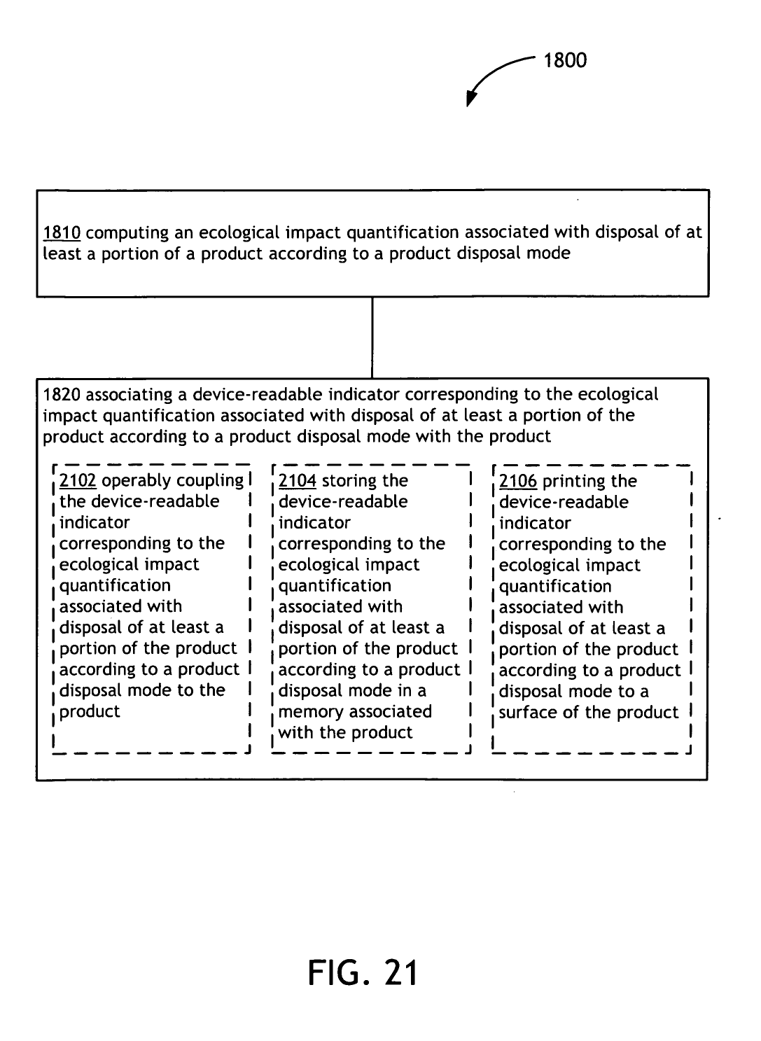

FIG. 21 illustrates an example embodiment where the operation 1804 of example operational flow 1800 of FIG. 18 may include at least one additional operation. Additional operations may include an operation 2102, 2104 and/or 2106.

Operation 2102 shows operably coupling the device-readable indicator corresponding to the ecological impact quantification associated with disposal of at least a portion of the product according to a product disposal mode to the product. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be associated with (e.g. stored in) a device (e.g. an RFID chip) as a device-readable indicator 314. The device-readable indicator 314 corresponding to the ecological impact quantification can then be associated with the product 102 by operably coupling (e.g. electrically connecting, wirelessly connecting, adhering, bolting, enclosing within, etc.) the device including the device-readable indicator 314 to the product 102.

Operation 2104 shows storing the device-readable indicator corresponding to the ecological impact quantification associated with disposal of at least a portion of the product according to a product disposal mode in a memory associated with the product. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be associated with (e.g. encoded as) a device-readable indicator 314. The device-readable indicator 314 can then be associated with the product 102 by storing the device-readable indicator corresponding to the ecological impact quantification in a memory associated with (e.g. electrically coupled to, physically coupled to, etc.) the product 102.

Operation 2106 shows printing the device-readable indicator corresponding to the ecological impact quantification associated with disposal of at least a portion of the product according to a product disposal mode to a surface of the product. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be associated with (e.g. encoded as) a device-readable indicator 314 (e.g. a barcode). The device-readable indicator 314 can then be associated with the product 102 by printing the device-readable indicator corresponding to the ecological impact quantification on a surface of the product 102.

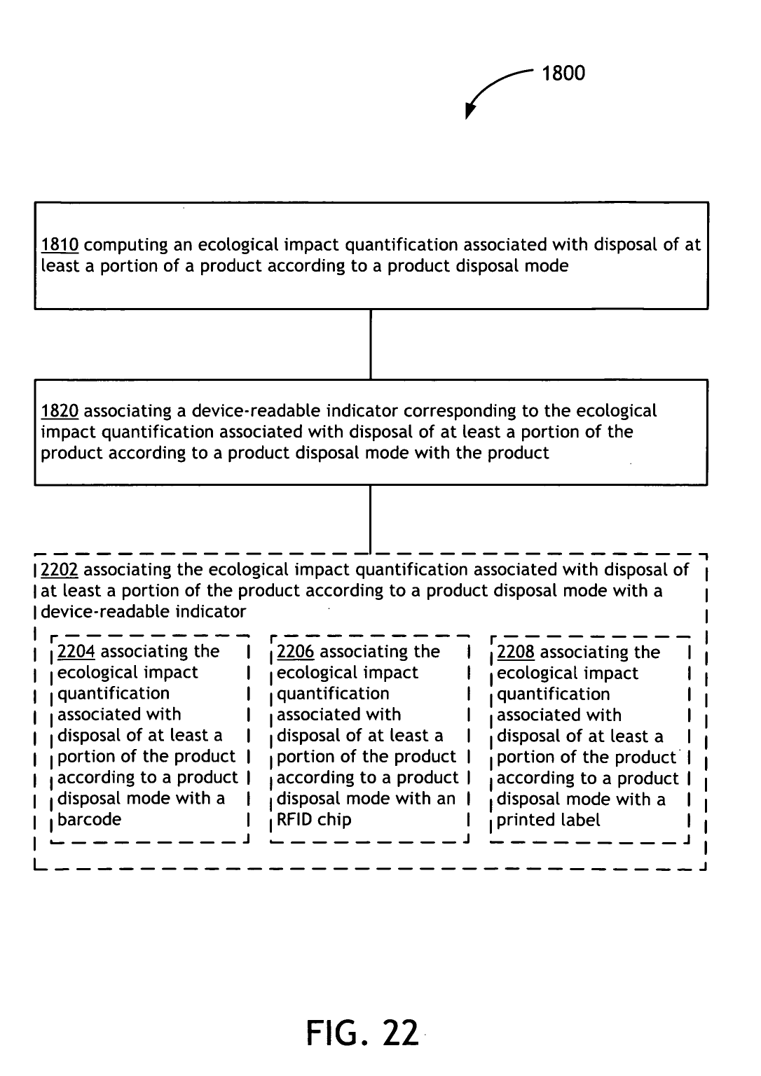

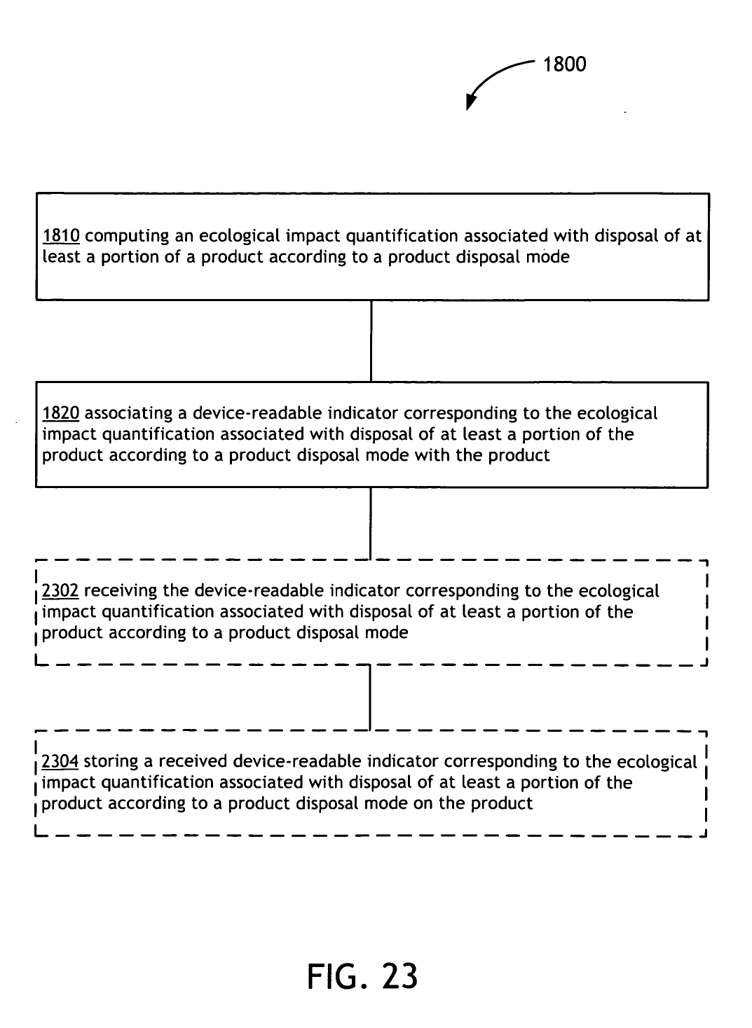

FIG. 22 illustrates an example embodiment where the operation 1804 of example operational flow 1800 of FIG. 18 may include at least one additional operation. Additional operations may include an operation 2202, 2204, 2206 and/or 1508.

Operation 2202 shows associating the ecological impact quantification associated with disposal of at least a portion of the product according to a product disposal mode with a device-readable indicator. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be associated with (e.g. encoded as, mapped to, stored in device including) the device-readable indicator 314.

Operation 2204 shows associating the ecological impact quantification associated with disposal of at least a portion of the product according to a product disposal mode with a barcode. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be encoded as barcode-type device-readable indicator 314 that may be printed to a surface of the product 102.

Operation 2206 shows associating the ecological impact quantification associated with disposal of at least a portion of the product according to a product disposal mode with an RFID chip. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be stored in an RFID-type device-readable indicator 314 that may be operably coupled to the product 102.

Operation 2208 shows associating the ecological impact quantification associated with disposal of at least a portion of the product according to a product disposal mode with a printed label. For example, following a computation of the ecological impact quantification associated with disposal of at least a portion of a product 102 according to product specification data (e.g. construction materials, disposal transportation data, disposal energy use data, etc.) and/or a disposal mode (e.g. resale, recycling, landfilling, etc.) received via the product specification module 401, the ecological impact quantification may be printed on a label-type device-readable indicator 314 which may be adhered to the product 102.

FIG. 123 illustrates an example embodiment where the example operational flow 1800 of FIG. 18 may include at least one additional operation. Additional operations may include an operation 2302 and/or 2304.

Operation 2302 shows receiving the device-readable indicator corresponding to the ecological impact quantification associated with disposal of at least a portion of the product according to a product disposal mode. For example, following receipt of product specification data and product disposal data by the system 106 associated with ecological service provider 112, the LCM 118 of system 106 may correlate that product specification data and product disposal data to disposal mode identifier table 214 and/or disposal phase quantification table 220 of database 114. The LCM 118 may compute an ecological impact quantification associated with the product specification data and product disposal data for the product from the disposal mode identifier table 214 and/or disposal phase quantification table 220 as described above with respect to operation 502. Following computation of the ecological impact quantification associated with disposal of at least a portion of the product 102, the ecological impact quantification may be associated with (e.g. encoded as, mapped to) a device-readable indicator 314. This device-readable indicator may then be transmitted to and received by the product 102 and/or the product specification module 401 The device-readable indicator may then be associated (e.g. stored in memory associated with the product 102, affixed as a barcode or other optically readable format, stored in an RFID) with the product 102.

Operation 2304 shows storing a received device-readable indicator corresponding to the ecological impact quantification associated with disposal of at least a portion of the product according to a product disposal mode on the product. Following receipt of the device-readable indicator 314 corresponding to an ecological impact quantification associated with disposal of at least a portion of the product 102, the device-readable indicator 314 may be stored to a memory or RFID chip on the product 102 which may be read by device 302 to access the device-readable indicator 314.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1. A system comprising:
means for computing an ecological impact quantification associated with manufacturing at least a portion of a product according to product specification data associated with the product; and
means for associating a device-readable indicator corresponding to the ecological impact quantification associated with manufacturing at least a portion of a product with a product manufactured at least partially according the product specification data.

2. The system of claim 1, wherein the means for computing an ecological impact quantification associated with manufacturing at least a portion of a product according to product specification data associated with the product comprises:
means for computing an ecological impact quantification associated with manufacturing at least a portion of a product according to product construction material identification data.

3. The system of claim 2, wherein the means for computing an ecological impact quantification associated with manufacturing at least a portion of a product according to product construction material identification data comprises:
means for computing an ecological impact quantification associated with manufacturing at least a portion of a product according to an amount of rare-earth materials in the product.

4. The system of claim 2, wherein the means for computing an ecological impact quantification associated with manufacturing at least a portion of a product according to product construction material identification data comprises:
means for computing an ecological impact quantification associated with manufacturing at least a portion of a product according to an amount of hazardous materials in the product.

5. The system of claim 2, wherein the means for computing an ecological impact quantification associated with manufacturing at least a portion of a product according to product construction material identification data comprises:
means for computing an ecological impact quantification associated with manufacturing at least a portion of a product according to an amount of ground pollutants in the product.

6. The system of claim 1, wherein the means for computing an ecological impact quantification associated with manufacturing at least a portion of a product according to product specification data associated with the product comprises:
means for computing an ecological impact quantification associated with manufacturing at least a portion of a product according to a carbon dioxide equivalent value associated with the manufacturing of at least a portion of the product.

7. The system of claim 6, wherein the means for computing an ecological impact quantification associated with manufacturing at least a portion of a product according to a carbon dioxide equivalent value associated with the manufacturing of at least a portion of the product comprises:
means for computing an ecological impact quantification associated with manufacturing at least a portion of a product according to product construction material transportation data.

8. The system of claim 6, wherein the means for computing an ecological impact quantification associated with manufacturing at least a portion of a product according to a carbon dioxide equivalent value associated with the manufacturing of at least a portion of the product comprises:
means for computing an ecological impact quantification associated with manufacturing at least a portion of a product according to product manufacturing energy use data.

9. The system of claim 6, wherein the means for computing an ecological impact quantification associated with manufacturing at least a portion of a product according to product specification data associated with the product comprises:
means for computing an ecological impact quantification associated with manufacturing at least a portion of a product according to product construction material waste data.

10. The system of claim 1, wherein the means for associating a device-readable indicator corresponding to the ecological impact quantification associated with manufacturing at least a portion of a product with a product manufactured at least partially according the product specification data comprise:
means for operably coupling a device including the device-readable indicator corresponding to the ecological impact quantification associated with manufacturing at least a portion of a product to the product.

11. The system of claim 1, wherein the means for associating a device-readable indicator corresponding to the ecological impact quantification associated with manufacturing at least a portion of a product with a product manufactured at least partially according the product specification data comprise:
means for storing the device-readable indicator corresponding to the ecological impact quantification associated with manufacturing at least a portion of a product in a memory associated with the product.

12. The system of claim 1, wherein the means for associating a device-readable indicator corresponding to the ecological impact quantification associated with manufacturing at least a portion of a product with a product manufactured at least partially according the product specification data comprise:
means for printing the device-readable indicator corresponding to the ecological impact quantification associated with manufacturing at least a portion of a product to a surface of the product.

13. The system of claim 1, further comprising:
means for associating the ecological impact quantification associated with manufacturing at least a portion of a product with a device-readable indicator.

14. The system of claim 13, wherein the means for associating the ecological impact quantification associated with manufacturing at least a portion of a product with a device-readable indicator comprises:
means for associating the ecological impact quantification associated with manufacturing at least a portion of a product with a barcode.

15. The system of claim 13, wherein the means for associating the ecological impact quantification associated with manufacturing at least a portion of a product with a device-readable indicator comprises:
means for associating the ecological impact quantification associated with manufacturing at least a portion of a product with an RFID chip.

16. The system of claim 13, wherein the means for associating the ecological impact quantification associated with manufacturing at least a portion of a product with a device-readable indicator comprises:
means for associating the ecological impact quantification associated with manufacturing at least a portion of a product with a printed label.

17. The system of claim 1, further comprising:
means for transmitting product specification data associated with manufacturing of the product.

18. The system of claim 1, further comprising:
means for receiving the device-readable indicator corresponding to the ecological impact quantification associated with manufacturing at least a portion of a product.

19. The system of claim 18, further comprising:
means for storing a received device-readable indicator corresponding to the ecological impact quantification associated with manufacturing at least a portion of a product on the product.

20. The system of claim 1, further comprising:
means for computing an ecological impact quantification associated with disposal of at least a portion of the product according to a product disposal mode; and
means for associating a device-readable indicator corresponding to the ecological impact quantification associated with disposal of at least a portion of the product according to a product disposal mode with the product.

21. The system of claim 20, wherein the computing an ecological impact quantification associated with disposal of at least a portion of the product according to a product disposal mode further comprises:
means for computing an ecological impact quantification associated with disposal of at least a portion of the product according to a resale disposal mode.

22. The system of claim 20, wherein the computing an ecological impact quantification associated with disposal of at least a portion of the product according to a product disposal mode further comprises:
means for computing an ecological impact quantification associated with disposal of at least a portion of the product according to a recycling disposal mode.

23. The system of claim 20, wherein the computing an ecological impact quantification associated with disposal of at least a portion of the product according to a product disposal mode further comprises:
means for computing an ecological impact quantification associated with disposal of at least a portion of the product according to a composting disposal mode.

24. The system of claim 20, wherein the computing an ecological impact quantification associated with disposal of at least a portion of the product according to a product disposal mode further comprises:
means for computing an ecological impact quantification associated with disposal of at least a portion of the product according to an incineration disposal mode.

25. The system of claim 20, wherein the computing an ecological impact quantification associated with disposal of at least a portion of the product according to a product disposal mode further comprises:
means for computing an ecological impact quantification associated with disposal of at least a portion of the product according to a landfilling disposal mode.

26. The system of claim 20, wherein the computing an ecological impact quantification associated with disposal of at least a portion of the product according to a product disposal mode further comprises:
means for computing an ecological impact quantification associated with disposal of at least a portion of the product according to an ocean floor disposal mode.

27. The system of claim 1, wherein the means for associating a device-readable indicator corresponding to the ecological impact quantification associated with disposal of at least a portion of the product according to a product disposal mode with the product comprise:
means for operably coupling the device-readable indicator corresponding to the ecological impact quantification associated with disposal of at least a portion of the product according to a product disposal mode to the product.

28. The system of claim 1, wherein the means for associating a device-readable indicator corresponding to the ecological impact quantification associated with disposal of at least a portion of the product according to a product disposal mode with the product comprise:
means for storing the device-readable indicator corresponding to the ecological impact quantification associated with disposal of at least a portion of the product according to a product disposal mode in a memory associated with the product.

29. The system of claim 1, wherein the means for associating a device-readable indicator corresponding to the ecological impact quantification associated with disposal of at least a portion of the product according to a product disposal mode with the product comprise:
means for printing the device-readable indicator corresponding to the ecological impact quantification associated with disposal of at least a portion of the product according to a product disposal mode to a surface of the product.

30. The system of claim 20, further comprising:
means for associating the ecological impact quantification associated with disposal of at least a portion of the product according to a product disposal mode with a device-readable indicator.

31. The system of claim 30, wherein the means for associating the ecological impact quantification associated with disposal of at least a portion of the product according to a product disposal mode with a device-readable indicator comprises:
means for associating the ecological impact quantification associated with disposal of at least a portion of the product according to a product disposal mode with a barcode.

32. The system of claim 30, wherein the means for associating the ecological impact quantification associated with disposal of at least a portion of the product according to a product disposal mode with a device-readable indicator comprises:
means for associating the ecological impact quantification associated with disposal of at least a portion of the product according to a product disposal mode with an RFID chip.

33. The system of claim 30, wherein the means for associating the ecological impact quantification associated with disposal of at least a portion of the product according to a product disposal mode with a device-readable indicator comprises:
means for associating the ecological impact quantification associated with disposal of at least a portion of the product according to a product disposal mode with a printed label.

34. The system of claim 20, further comprising:
means for receiving the device-readable indicator corresponding to the ecological impact quantification associated with disposal of at least a portion of the product according to a product disposal mode.

35. The system of claim 34, further comprising:
means for storing a received device-readable indicator corresponding to the ecological impact quantification associated with disposal of at least a portion of the product according to a product disposal mode on the product.

36. A computer implemented method comprising:
computing an ecological impact quantification associated with manufacturing at least a portion of a product according to product specification data associated with the product; and
associating a device-readable indicator corresponding to the ecological impact quantification associated with manufacturing at least a portion of a product with a product manufactured at least partially according the product specification data.

37. A system comprising:
circuitry for computing an ecological impact quantification associated with manufacturing at least a portion of a product according to product specification data associated with the product; and
circuitry for associating a device-readable indicator corresponding to the ecological impact quantification associated with manufacturing at least a portion of a product with a product manufactured at least partially according the product specification data

38. (canceled)

39. A system comprising:
means for computing an ecological impact quantification associated with disposal of at least a portion of the product according to a product disposal mode; and
means for associating a device-readable indicator corresponding to the ecological impact quantification associated with disposal of at least a portion of the product according to a product disposal mode with the product.

40. The system of claim 39, wherein the computing an ecological impact quantification associated with disposal of at least a portion of the product according to a product disposal mode further comprises:
means for computing an ecological impact quantification associated with disposal of at least a portion of the product according to a resale disposal mode.

41. The system of claim 39, wherein the computing an ecological impact quantification associated with disposal of at least a portion of the product according to a product disposal mode further comprises:
means for computing an ecological impact quantification associated with disposal of at least a portion of the product according to a recycling disposal mode.

42. The system of claim 39, wherein the computing an ecological impact quantification associated with disposal of at least a portion of the product according to a product disposal mode further comprises:
means for computing an ecological impact quantification associated with disposal of at least a portion of the product according to a composting disposal mode.

43. The system of claim 39, wherein the computing an ecological impact quantification associated with disposal of at least a portion of the product according to a product disposal mode further comprises:
means for computing an ecological impact quantification associated with disposal of at least a portion of the product according to an incineration disposal mode.

44. The system of claim 39, wherein the computing an ecological impact quantification associated with disposal of at least a portion of the product according to a product disposal mode further comprises:
means for computing an ecological impact quantification associated with disposal of at least a portion of the product according to a landfilling disposal mode.

45. The system of claim 39, wherein the computing an ecological impact quantification associated with disposal of at least a portion of the product according to a product disposal mode further comprises:
means for computing an ecological impact quantification associated with disposal of at least a portion of the product according to an ocean floor disposal mode.

46. The system of claim 39, wherein the means for associating a device-readable indicator corresponding to the ecological impact quantification associated with disposal of at least a portion of the product according to a product disposal mode with the product comprise:
means for operably coupling the device-readable indicator corresponding to the ecological impact quantification associated with disposal of at least a portion of the product according to a product disposal mode to the product.

47. The system of claim 39, wherein the means for associating a device-readable indicator corresponding to the ecological impact quantification associated with disposal of at least a portion of the product according to a product disposal mode with the product comprise:
means for storing the device-readable indicator corresponding to the ecological impact quantification associated with disposal of at least a portion of the product according to a product disposal mode in a memory associated with the product.

48. The system of claim 39, wherein the means for associating a device-readable indicator corresponding to the ecological impact quantification associated with disposal of at least a portion of the product according to a product disposal mode with the product comprise:
means for printing the device-readable indicator corresponding to the ecological impact quantification associated with disposal of at least a portion of the product according to a product disposal mode to a surface of the product.

49. The system of claim 39, further comprising:
means for associating the ecological impact quantification associated with disposal of at least a portion of the product according to a product disposal mode with a device-readable indicator.

50. The system of claim 49, wherein the means for associating the ecological impact quantification associated with disposal of at least a portion of the product according to a product disposal mode with a device-readable indicator comprises:
means for associating the ecological impact quantification associated with disposal of at least a portion of the product according to a product disposal mode with a barcode.

51. The system of claim 49, wherein the means for associating the ecological impact quantification associated with disposal of at least a portion of the product according to a product disposal mode with a device-readable indicator comprises:
means for associating the ecological impact quantification associated with disposal of at least a portion of the product according to a product disposal mode with an RFID chip.

52. The system of claim 49, wherein the means for associating the ecological impact quantification associated with disposal of at least a portion of the product according to a product disposal mode with a device-readable indicator comprises:
means for associating the ecological impact quantification associated with disposal of at least a portion of the product according to a product disposal mode with a printed label.

53. The system of claim 39, further comprising:
means for receiving the device-readable indicator corresponding to the ecological impact quantification associated with disposal of at least a portion of the product according to a product disposal mode.

54. The system of claim 53, further comprising:
means for storing a received device-readable indicator corresponding to the ecological impact quantification associated with disposal of at least a portion of the product according to a product disposal mode on the product.

55. A computer implemented method comprising:
computing an ecological impact quantification associated with disposal of at least a portion of the product according to a product disposal mode; and
associating a device-readable indicator corresponding to the ecological impact quantification associated with disposal of at least a portion of the product according to a product disposal mode with the product.

56. A system comprising:
circuitry for computing an ecological impact quantification associated with disposal of at least a portion of the product according to a product disposal mode; and
circuitry for associating a device-readable indicator corresponding to the ecological impact quantification associated with disposal of at least a portion of the product according to a product disposal mode with the product.

57. (canceled)
